(19) United States
(12) Patent Application Publication
(10) Pub. No.: US 2018/0271025 A1
(43) Pub. Date: Sep. 27, 2018

(54) METHODS FOR PROVIDING HEIGHT ENHANCED GRAFTED PLANTS AND PRODUCTS THEREOF

(71) Applicant: Hishtil LTD., Moshav Nehalim (IL)

(72) Inventors: Amit Dagan, Moshav Mazor (IL); Menachem Shadmi, Yavne (IL); Alon Perri, Moshav Mazor (IL)

(73) Assignee: Hishtil LTD., Moshav Nehalim (IL)

(21) Appl. No.: 15/523,308

(22) PCT Filed: Oct. 28, 2015
(86) PCT No.: PCT/IL2015/051056

§ 371 Date: Apr. 28, 2017

Related U.S. Application Data
(60) Provisional application No. 62/069,866, filed on Oct. 29, 2014.

(51) Int. Cl. A01G 2/30

(52) U.S. Cl. CPC A01G 2/30; A01G 22/00

(57) ABSTRACT

The present invention discloses a high stem grafted herbaceous plant. The high stem grafted plant comprises herbaceous scion engrafted upon a rootstock at a predetermined height of at least 7 cm. The present invention further provides novel high stem grafted propagation material and methods for producing the high stem grafted herbaceous plant.

### FIELD OF THE INVENTION

The present invention generally relates to the field of grafted plants as well as to a method for providing grafted plants.

### BACKGROUND OF THE INVENTION

Grafting is a horticultural technique used to combine one plant part with another to encourage growth as a unified plant. In this technique, tissues from one plant are inserted into those of another so that the two sets of vascular tissues may join together. This vascular joining is called inoculation. In most cases, one plant is selected for its roots and this is called the stock or rootstock. The other plant is selected for its stems (although stems may also sometimes be sought after as a merit derived from the stock), leaves, flowers, or fruits and is called the scion. The scion contains the desired genes to be duplicated in future production by the stock/scion plant. In other words, the scion is the part of the stem that develops into a shoot system following successful grafting. The stock or rootstock is the part that develops into a root system following successful grafting. Both rootstock and scion may be grown from seed or from cuttings.

The grafting technique is most commonly used in asexual propagation of commercially grown plants for the horticultural and agricultural trades. More specifically, grafting is used as a method of choice to: 1) propagate plants when relatively simpler methods such as stem cuttings or seeds are ineffective, climatic or soil conditions are unfavorable, or major modifications to plant architecture are required; 2) change plant cultivars; and 3) repair damaged plants. For example, if a fruit cultivar has lost consumer acceptability, a more desirable cultivar can be grafted onto the existing mature plant by top working. This procedure is more economical than developing a new cultivar. In general, grafting is commercially the most cost-effective way of raising a particular type of plant.

Grafting can also be used to repair damaged plant parts. In addition, grafting can produce interesting and new plant combinations.

Grafting of woody plants has been common for centuries, but herbaceous grafting has only recently become popular as an agricultural method.

Herbaceous plants are plants that have leaves and stems that die down at the end of the growing season to the soil level. They have no persistent woody stem above ground. Herbaceous plants may be annuals, biennials or perennials.

Annual herbaceous plants die completely at the end of the growing season or when they have flowered and fruited, and they then grow again from seed. Herbaceous perennial and biennial plants have leaves (sometimes also stems) that die at the end of the growing season, but parts of the plant survive under or close to the ground from season to season (for biennials, until the next growing season, when they flower and die). Examples of herbaceous biennials include carrot, parsnip and common ragwort; examples of herbaceous perennials include potato, peony, hosta, mint, most ferns and most grasses.

Herbaceous plant grafting became popular as a way to reduce certain diseases caused by soil borne plant pathogens and tolerance to abiotic stress like flooding, drought, extreme temperature and salinity.

Currently, however, it is apparent that there is a long felt and unmet need for producing new designs and combinations of grafted plants, and especially herbaceous grafted plants having ornamental and other properties that are highly commercially desirable.

### SUMMARY OF THE INVENTION

It is therefore one object of the present invention to disclose a high stem grafted herbaceous plant, wherein said grafted plant comprises herbaceous scion engrafted upon a rootstock at a predetermined height of at least 7 cm.

It is a further object of the present invention to disclose the high stem grafted herbaceous plant as defined above, wherein said scion is engrafted upon said rootstock at a predetermined height of between about 7 cm and about 50 cm.

It is a further object of the present invention to disclose the high stem grafted herbaceous plant as defined in any of the above, wherein said scion is engrafted upon said rootstock at a predetermined height of between about 10 cm and about 50 cm.

It is a further object of the present invention to disclose the high stem grafted herbaceous plant as defined in any of the above, wherein said scion is of length of between about 7 cm and about 30 cm.

It is a further object of the present invention to disclose the high stem grafted herbaceous plant as defined in any of the above, wherein said scion is compatible with said rootstock.

It is a further object of the present invention to disclose the high stem grafted herbaceous plant as defined in any of the above, wherein said rootstock is herbaceous plant.

It is a further object of the present invention to disclose the high stem grafted herbaceous plant as defined in any of the above, wherein said scion and/or said rootstock is derived from a hybrid plant.

It is a further object of the present invention to disclose the high stem grafted herbaceous plant as defined in any of the above, wherein said scion and/or said rootstock belongs to a family selected from the group consisting of: Solanaceae, Lamiaceae (or Labiatae), Lobeliaceae, Asteraceae, Scrophulariaceae, Caryophyllaceae, Cucurbitaceae, and any combination thereof.

It is a further object of the present invention to disclose the high stem grafted herbaceous plant as defined in any of the above, wherein said scion and/or said rootstock is a genus selected from the group consisting of Solanum, Capsicum, Petunia, Calibrachoa, Physalis and Ocimum and any combination thereof.

It is a further object of the present invention to disclose the high stem grafted herbaceous plant as defined in any of the above, wherein said scion and/or said rootstock is a species selected from the group consisting of: Solanum melongena, S. betaceum (Tamarillo) and Physalis philadelphica (Tomatillo) and any combination thereof.

It is a further object of the present invention to disclose the high stem grafted herbaceous plant as defined in any of the above, wherein said scion is selected from the group consisting of: ‘Lobelia’, ‘Lobelia erinus’, Gerbera, Gazania, Bidens, Bidens ferulifolia, Bacopa, Bacopa monnieri, Dianthus, Dianthus chinensis, Angelonia, Lycopersicon lycopersicum, Lycopersicon lycopersicum cherry tomatoes, Thymus, Lavandula, Origanum, Salvia, Artemisia, Artemisia abrotanum and Majorana syriaca zaatar and any combination thereof.

It is a further object of the present invention to disclose the high stem grafted herbaceous plant as defined in any of the above, wherein said scion is selected from the group of Capsicum species consisting of: C. annuum, C. baccatuum, C. chinense, C. frutescents and C. pubescen and any combination thereof.

It is a further object of the present invention to disclose the high stem grafted herbaceous plant as defined in any of the above, wherein said scion is an ornamental pepper variety or cultivar.

It is a further object of the present invention to disclose the high stem grafted herbaceous plant as defined in any of the above, wherein said scion is an ornamental pepper variety or cultivar of a Capsicum annuum species.

It is a further object of the present invention to disclose the high stem grafted herbaceous plant as defined in any of the above, wherein said scion is of the Ocimum basilicum species.

It is a further object of the present invention to disclose the high stem grafted herbaceous plant as defined in any of the above, wherein said scion is selected from the group of Ocimum species, cultivars or varieties consisting of: Ocimum×africanum, Ocimum americanum, Ocimum amicorum, Ocimum angustifolium, Ocimum basilicum, Ocimum burchellianum, Ocimum campechianum, Ocimum canescens, Ocimum carnosum, Ocimum centraliafricanum, Ocimum circinatum, Ocimum coddii, Ocimum cufodontii, Ocimum dambicola, Ocimum decumbens, Ocimum dhofarense, Ocimum dolomiticola, Ocimum ellenbeckii, Ocimum empetroides, Ocimum ericoides, Ocimum filamentosum, Ocimum fimbriatum, Ocimum fischeri, Ocimum formosum, Ocimum forskoelei, Ocimum fruticosum, Ocimum grandiflorum, Ocimum gratissimum, Ocimum hirsutissimum, Ocimum irvinei, Ocimum jamesii, Ocimum kenyense, Ocimum kilimandscharicum, Ocimum labiatum, Ocimum lamiifolium, Ocimum masaiense, Ocimum mearnsii, Ocimum metallorum, Ocimum minimum, Ocimum minutiflorum, Ocimum mitwabense, Ocimum monocotyloides, Ocimum motjaneanum, Ocimum natalense, Ocimum nudicaule, Ocimum nummularia, Ocimum obovatum, Ocimum ovatum, Ocimum pseudoserratum, Ocimum pyramidatum, Ocimum reclinatum, Ocimum serpyllifolium, Ocimum serratum, Ocimum somaliense, Ocimum spectabile, Ocimum spicatum, Ocimum tenuiflorum, Ocimum transamazonicum, Ocimum tubiforme, Ocimum urundense, Ocimum vandenbrandei, Ocimum vanderystii, Ocimum viphyense, Ocimum waterbergense, Ocimum×citriodorum (O. americanum×O. basilicum), Lemon basil, Ocimum kilimandscharicum×basilicum ‘Dark Opal’, African blue basil, basilicum, kilimandscharicum, minimum, herbalea, ‘Globe’ basil, ‘dwarf’ basil, ‘French’ basil, Ocimum basilicum var. minimum ‘Greek’ Basil, entries of Ocimum accessions described in Table 1 of Yariv Ben Naim et al (2015) Resistance Against Basil Downy Mildew in Ocimum Species, Genetics and Resistance Vol. 105 and any combination thereof.

It is a further object of the present invention to disclose the high stem grafted herbaceous plant as defined in any of the above, wherein said scion is selected from the group of Calibrachoa species consisting of: Calibrachoa caesia, Calibrachoa calycina, Calibrachoa dusenii, Calibrachoa eglandulata, Calibrachoa elegans, Calibrachoa ericaefolia, Calibrachoa excellens, Calibrachoa hassleriana, Calibrachoa heterophylla, Calibrachoa humilis, Calibrachoa linearis, Calibrachoa parviflora, Calibrachoa pygmaea, Calibrachoa rupestris, Calibrachoa sellowiana, Calibrachoa spathulata and Calibrachoa thymifolia.

It is a further object of the present invention to disclose the high stem grafted herbaceous plant as defined in any of the above, wherein said rootstock belongs to a family selected from the group consisting of Solanaceae and Lamiaceae or Labiatae.

It is a further object of the present invention to disclose the high stem grafted herbaceous plant as defined in any of the above, wherein said rootstock is selected from the group consisting of Cestroideae, Goetzeoideae, Nicotianoideae, Petunioideae, Schizanthoideae, Schwenckioideae and Solanoideae subfamily.

It is a further object of the present invention to disclose the high stem grafted herbaceous plant as defined in any of the above, wherein said rootstock and/or said scion is selected from the group of Capsicum species consisting of: Capsicum annuum, Capsicum annuum L., Capsicum baccatum L., Capsicum buforum Hunz., Capsicum campylopodium Sendtn., Capsicum cardenasii Heiser & P. G. Sm., Capsicum ceratocalyx M. Nee, Capsicum chacoense Hunz., Capsicum chinense Jacq., Capsicum coccineum (Rusby) Hunz., Capsicum cornutum (Hiern) Hunz., Capsicum dimorphum (Miers) Kuntze, Capsicum dusenii Bitter, Capsicum eximium Hunz., Capsicum flexuosum Sendtn., Capsicum friburgense Bianch. & Barboza, Capsicum frutescens L., Capsicum galapagoense Hunz., Capsicum geminifolium (Dammer) Hunz., Capsicum havanense Kunth, Capsicum hookerianum (Miers) Kuntze, Capsicum hunzikerianum Barboza & Bianch., Capsicum lanceolatum (Greenm.) C. V. Morton & Standl., Capsicum leptopodum (Dunal) Kuntze, Capsicum lycianthoides Bitter, Capsicum minutiflorum (Rusby) Hunz., Capsicum mirabile Mart. ex Sendtn., Capsicum mositicum Toledo, Capsicum parvifolium Sendtn., Capsicum pereirae Barboza & Bianch., Capsicum pubescens Ruiz & Pay., Capsicum ramosissimum Witasek, Capsicum recurvatum Witasek, Capsicum rhomboideum (Dunal) Kuntze, Capsicum schottianum Sendtn., Capsicum scolnikianum Hunz., Capsicum spina-alba (Dunal) Kuntze, Capsicum stramoniifolium (Kunth) Standl., Capsicum tovarii Eshbaugh et al., Capsicum villosum Sendtn.

It is a further object of the present invention to disclose the high stem grafted herbaceous plant as defined in any of the above, wherein said rootstock is selected from the group of Petunia species consisting of: P. alpicola, P. altiplana, P. axillaris, P. bajeensis, P. bonjardinensis, P. exserta, P. guarapuavensis, P. helianthemoides, P. humifusa, P. inflate, P. integrifolia, P. interior, P. ledifolia, P. littoralis, P. mantiqueirensis, P. occidentalis, P. parviflora, P. patagonica, P. pubescens, P. reitzii, P. riograndensis, P. saxicola, P. scheideana, P. variabilis, P. villadiana, P.×atkinsiana and P. hybrida.

It is a further object of the present invention to disclose the high stem grafted herbaceous plant as defined in any of the above, wherein said rootstock is selected from the group of species consisting of: Capsicum annuum, Ocimum basilicum, Ocimum kilimandscharicum, Ocimum kilimandscharicum×O. basilicum F1, Solanum lycopersicum L., S. tuberosum and S. melongena.

It is a further object of the present invention to disclose the high stem grafted herbaceous plant as defined in any of the above, wherein said grafted plant comprises engrafted pairs of compatible rootstock and scion selected from the group consisting of a rootstock of the Petunia genus engrafted with a scion of the Calibrachoa genus, a rootstock of the Capsicum annuum species engrafted with a scion of the Ornamental pepper Capsicum annuum species, a rootstock of the Ocimum species engrafted with a scion of the Ocimum species, a rootstock of the solanum lycopersicum species engrafted with a scion of the S. lycopersicum species, a rootstock of the solanum melongena species engrafted with a scion of the S. lycopersicum species, a rootstock of the solanum melongena species engrafted with a scion of the S. melongena species, and a rootstock of the Origanum vulgare species engrafted with a scion of the O. vulgare species.

It is a further object of the present invention to disclose the high stem grafted herbaceous plant as defined in any of the above, wherein said grafted plant is derived from grafted high stem propagation material selected from the group consisting of grafted high stem young plants and grafted high stem unrooted raw material.

It is a further object of the present invention to disclose the high stem grafted herbaceous plant as defined in any of the above, wherein said young plants are selected from the group consisting of rooted cuttings, seedlings, grafted high stem rooted cuttings and grafted high stem seedlings.

It is a further object of the present invention to disclose the high stem grafted herbaceous plant as defined in any of the above, wherein said unrooted raw material is selected from the group consisting of unrooted cuttings and grafted high stem unrooted cuttings.

It is a further object of the present invention to disclose the high stem grafted herbaceous plant as defined in any of the above, wherein said unrooted raw material is adapted for insertion and growth in plug trays.

It is a further object of the present invention to disclose the high stem grafted herbaceous plant as defined in any of the above, wherein said grafted high stem unrooted raw material is adapted for perpendicular stability and/or sturdiness when planted in a plug tray.

It is a further object of the present invention to disclose a high stem grafted finished plant derived from the propagation material as defined in any of the above.

It is a further object of the present invention to disclose the high stem grafted finished plant as defined in any of the above, wherein said plant is adapted for perpendicular stability and/or sturdiness when planted in a pot or planting container.

It is a further object of the present invention to disclose the high stem grafted finished plant as defined in any of the above, wherein said plant is adapted for planting as bedding plants.

It is a further object of the present invention to disclose the high stem grafted herbaceous plant as defined in any of the above, wherein said rootstock has at least one compatible characteristic with said scion.

It is a further object of the present invention to disclose the high stem grafted herbaceous plant as defined in any of the above, wherein said at least one compatible characteristic is selected from the group consisting of: stem diameter, growth pattern, taxonomical similarity, genetic similarity, anatomical similarity, growth rate, enhanced or reduced flowering, enhanced or reduced fruit size, enhanced or reduced fruit yield, internode number, internode diameter, internode and/or stem color, stem habit, root stock and/or scion woodification, and any combination thereof.

It is a further object of the present invention to disclose the high stem grafted herbaceous plant as defined in any of the above, wherein said rootstock and/or said scion has at least one desirable agronomical, horticultural and/or ornamental characteristic.

It is a further object of the present invention to disclose the high stem grafted herbaceous plant as defined in any of the above, wherein said at least one desirable agronomical, horticultural and/or ornamental characteristic of said rootstock is selected from the group consisting of strong root system, enhanced stem height or high stem, plant vigor, vigorous growth, sturdiness, stress tolerance, resistance or tolerance to biotic stress, resistance or tolerance to disease agents such as viruses, bacteria, fungi, resistance or tolerance to pests and weeds, disease resistance or tolerance, pest resistance or tolerance, resistance to pathogens, resistance to insect infestation, prevention of contaminants penetration to the scion, resistance to abiotic stress, resistance to nutrient deficiencies, improved seed yield, improved growth rate, desirable interaction between said rootstock and said scion, induced dwarfism, induced scion-crown density, enhanced vigor, induced sturdiness and/or thickness of said rootstock, enhanced germination, enhanced rooting potential, minimal sprout differentiation from callus, minimal side-shoots from the rootstock stem, enhanced rootstock stem thickness, maximal elongation of internodes, robustness, straight stem, thickness and any combination thereof.

It is a further object of the present invention to disclose the high stem grafted herbaceous plant as defined in any of the above, wherein the stress tolerance characteristic comprises an abiotic stress tolerance characteristic selected from the group consisting of cold tolerance, high temperature tolerance, drought tolerance, flood tolerance, salt tolerance, ionic phytotoxicity tolerance, pH tolerance and any combination thereof.

It is a further object of the present invention to disclose the high stem grafted herbaceous plant as defined in any of the above, wherein the stress tolerance characteristic comprises a biotic stress tolerance characteristic selected from the group consisting of a disease resistance, an insect resistance, tolerance to parasitic weeds, a nematode resistance, improved resistance to soil borne pests and any combination thereof.

It is a further object of the present invention to disclose the high stem grafted herbaceous plant as defined in any of the above, wherein said desirable agronomical and/or horticultural characteristic is selected from the group consisting of a rooting potential of at least 80%, sprout differentiation from callus lower than 80%, side shoots from the stem lower than 90%, average stem thickness of at least 5 mm, average internode length of at least 10 mm and any combination thereof.

It is a further object of the present invention to disclose the high stem grafted herbaceous plant as defined in any of the above, wherein said rootstock is engrafted with at least two different scions said scions belong to different varieties and are compatible with said rootstock.

It is a further object of the present invention to disclose the high stem grafted herbaceous plant as defined in any of the above, wherein said different scions have at least one different characteristic selected from the group consisting of: inflorescence color, fruit shape, growth pattern and any combination thereof.

It is a further object of the present invention to disclose the high stem grafted herbaceous plant as defined in any of the above, wherein said scion is characterized by at least one characteristic selected from the group consisting of dense flowering, unique flower color, low to moderate incompatibility with the rootstock, at least 50% output of developed plants, desirable aroma, enhanced fruit yield, dense foliage, upright fruits, small conic fruits, many fruits in cluster, different colors, short nodes, compact crown, many branches, unripe fruits, large fruits, un-clustered fruits, short to medium internodes, vigorousness, large and tall crown, compactness, branched, colourful fruits, sweet taste, non-pungent fruits, non-toxic, long internodes, high yield, multiple taste, multiple flower colors, dwarf and compact, tolerance to root and foliage diseases, crown shape, standard commercial yield, stress tolerance, dense flowering, unique colors, natural ball-shaped crown, creeping stems, and any combination thereof.

It is a further object of the present invention to disclose the high stem grafted herbaceous plant as defined in any of the above, wherein said high stem grafted plant has at least one desirable ornamental, horticultural and/or agronomical characteristic relative to a corresponding non-grafted scion plant, said at least one characteristic is selected from the group consisting of: desirable ornamental or esthetic design, enhanced height or high stem plant, avoidance of new root development or secondary root development from the upper parts of the plant, limitation of pruning wounds, sturdiness, strong root system, tolerance to biotic stress, tolerance to abiotic stress, tolerance to soil borne pests and diseases, tolerance to parasitic weeds, prevention of contaminants penetration to the scion, uniformity, reduced leaf yellowing, robust growth, plant vigor, vigorous growth, enhanced inflorescence yield, enhanced fruit yield, enhanced fruit size, enhanced fruit number, enhanced yield of plant propagation material such as cuttings, enhanced aerial yield, combination of more than one species or variety on one plant, normal development similar to a corresponding non-grafted control plant, and any combination thereof.

It is a further object of the present invention to disclose the high stem grafted herbaceous plant as defined in any of the above, wherein said high stem grafted plant is planted into a final commercial planter or pot or any other growing container, or bedding.

It is a further object of the present invention to disclose the high stem grafted herbaceous plant as defined in any of the above, wherein said high stem rootstock is compatible with grafting machines or other automatic and/or mechanic agro techniques.

It is a further object of the present invention to disclose the high stem grafted herbaceous plant as defined in any of the above, wherein said final commercial planter or pot or any other growing container has a volume of 1 liter and less.

It is a further object of the present invention to disclose the high stem grafted herbaceous plant as defined in any of the above, wherein said final commercial planter or pot or any other growing container has a volume of 1 liter and more.

It is a further object of the present invention to disclose the high stem grafted herbaceous plant as defined in any of the above, wherein said final commercial planter or pot or any other growing container has a volume of between about 0.1 liter and about 2 liter.

It is a further object of the present invention to disclose the cuttings or unrooted cuttings, grafted cuttings or grafted unrooted cuttings derived from the high stem grafted herbaceous plant as defined in any of the above.

It is a further object of the present invention to disclose any plant part of the high stem grafted herbaceous plant as defined in any of the above.

It is a further object of the present invention to disclose the plant part as defined in any of the above, wherein said plant part is selected from the group consisting of rooted cuttings, unrooted cuttings, grafted rooted cuttings, unrooted grafted cuttings, plant cell, tissue culture, meristem, flowers and any other vegetative or reproductive part of the plant.

It is a further object of the present invention to disclose high stem grafted propagation material, wherein said high grafted stem propagation material comprises a scion engrafted upon a rootstock at a predetermined height of at least 7 cm, further wherein said high stem propagation material is selected from the group consisting of grafted high stem young plants, grafted high stem rooted cuttings, grafted high stem unrooted cuttings and grafted high stem seedlings.

It is a further object of the present invention to disclose a method for producing a high stem grafted herbaceous plant comprising steps of: (a) providing a herbaceous scion plant; (b) selecting a rootstock which is compatible with said scion plant; (c) growing said rootstock under predetermined agrotechnical conditions so as to produce a rootstock with a predetermined stem height of at least 7 cm and growth characteristics suitable for grafting with said scion; (d) growing said herbaceous scion plant under agrotechnical conditions, so as to provide a scion with growth characteristics suitable for grafting with said rootstock; and (e) grafting said scion onto said rootstock at said predetermined stem height of at least 7 cm, thereby producing a high stem grafted herbaceous plant.

It is a further object of the present invention to disclose the method as defined above, further comprises steps of growing said rootstock to a predetermined height of about 10 cm and up to 50 cm.

It is a further object of the present invention to disclose the method as defined in any of the above, comprising additional steps of adjusting the density of the grown rootstock plants by controlling the number of plants per area.

It is a further object of the present invention to disclose the method as defined in any of the above, comprising additional steps of selecting a growth tray suitable for growing said rootstock by parameters selected from the group consisting of size, shape of cells, material, density and any combination thereof.

It is a further object of the present invention to disclose the method as defined in any of the above, comprising additional steps of selecting said agrotechnical conditions from the group consisting of: growth media, fertilizing solution and regime, irrigation regime, temperature, relative humidity, electrical conductivity, illuminating level, shading level, illumination or radiation regime, pH and any combination thereof.

It is a further object of the present invention to disclose the method as defined in any of the above, comprising additional steps of selecting said growth characteristics from the group consisting of: stem diameter, stem height, flowering time, hypocotyl size, hypocotyl length, nodes number, node length, internode number, internode diameter, internode and/or stem color, stem habit, root stock and/or scion woodification, growth pattern and any combination thereof.

It is a further object of the present invention to disclose the method as defined in any of the above, comprising additional steps of controlling at least one parameter of said grown rootstock, said at least one parameter is selected from the group consisting of hypocotyl size, hypocotyl length, stem diameter, nodes number, internode length, woodification, and any combination thereof.

It is a further object of the present invention to disclose the method as defined in any of the above, comprising additional steps of growing said rootstock plant for a period of between about 30 days to about 45 days from planting until grafting, depending on the growth season.

It is a further object of the present invention to disclose the method as defined in any of the above, comprising additional steps of growing said scion for about 25 days to about 35 days from planting until grafting, depending on the growth season.

It is a further object of the present invention to disclose the method as defined in any of the above, comprising additional steps of regulating the growth of said rootstock and/or scion.

It is a further object of the present invention to disclose the method as defined in any of the above, comprising additional steps of regulating said growth by means selected from the group consisting of applying controlled Low-Radiation regimes for obtaining etiolated rootstock plants, applying predetermined wave length regimes, applying plant growth regulators (PGRs) such as plant hormones, phytohormones and chemicals.

It is a further object of the present invention to disclose the method as defined in any of the above, comprising additional steps of controlling the flowering timing of the grown rootstock plants by affecting photoperiodic response of the plants.

It is a further object of the present invention to disclose the method as defined in any of the above, further comprises steps of grafting said scion onto said rootstock by a grafting technique selected from the group consisting of: splice grafting, bud grafting, cleft grafting, side grafting, approach grafting, tongue approach grafting, tube-grafting, hole insertion grafting, one cotyledon grafting, whip grafting, stub grafting, four flap grafting, awl grafting, veneer grafting and by any other grafting technique suitable for grafting herbaceous plant and any combination thereof.

It is a further object of the present invention to disclose the method as defined in any of the above, comprising additional steps of using trailing and stabilizing means for supporting and shaping the grown rootstock or the grafted high stem plant.

It is a further object of the present invention to disclose the method as defined in any of the above, comprising additional steps of selecting said trailing and stabilizing means from the group consisting of sticks, clips, flowers cutting, trailing net, plastic tray frame and any combination thereof.

It is a further object of the present invention to disclose the method as defined in any of the above, comprising additional steps of applying plant protection treatments selected from the group consisting of: pesticide-based treatment, herbicides treatment, insecticides treatment, fungicides treatment, biological pest control treatment, physical treatment such as heat, cold, light, high-pressure or vacuum, spraying with gas or liquids, immersion in liquids or oils and any combination thereof.

It is a further object of the present invention to disclose the method as defined in any of the above, further comprises steps of enhancing adhesion and healing processes between said scion and said rootstock to form a graft union.

It is a further object of the present invention to disclose the method as defined in any of the above, wherein said step of enhancing adhesion and healing between said scion and said rootstock to form a graft union is performed for a period of about 14 days to about 21 days after the grafting step.

It is a further object of the present invention to disclose the method as defined in any of the above, further comprises steps of planting said grafted plant into a final commercial planter or pot or any other growing container or bedding.

It is a further object of the present invention to disclose the method as defined in any of the above, further comprises steps of planting said grafted plant into a final commercial planter or pot or any other growing container having a volume of 1 liter and less.

It is a further object of the present invention to disclose the method as defined in any of the above, further comprises steps of planting said grafted plant into a final commercial planter or pot or any other growing container having a volume of 1 liter and more.

It is a further object of the present invention to disclose the method as defined in any of the above, further comprises steps of planting said grafted plant into a final commercial planter or pot or any other growing container having a volume of between about 0.1 liter and about 2 liter.

It is a further object of the present invention to disclose the method as defined in any of the above, further comprises steps of growing said grafted plant in said final commercial planter or pot or any other growing container for about 60 days to about 90 days to achieve a high stem grafted plant suitable for marketing to a late stage in the supply chain such as end user or florists.

It is a further object of the present invention to disclose the method as defined in any of the above, further comprises steps of producing a high stem grafted herbaceous plant with desirable ornamental and/or horticultural characteristics relative to a corresponding non-grafted scion plant selected from the group consisting of: desirable ornamental or esthetic design, enhanced height or high stem plant, avoidance of new root development or secondary root development from the upper parts of the plant, limitation of pruning wounds, strong root system, tolerance to biotic stress, tolerance to abiotic stress, tolerance to parasitic weeds, uniformity, reduced leaf yellowing, robust growth, enhanced inflorescence yield, enhanced yield of plant propagation material such as cuttings, enhanced aerial yield, new ornamental design, combination of more than one species or variety on one rootstock plant and any combination thereof.

It is a further object of the present invention to disclose any part of a high stem grafted herbaceous plant produced by the method as defined in any of the above.

It is a further object of the present invention to the plant part as defined in any of the above, wherein said plant part is selected from the group consisting of rooted cuttings, unrooted cuttings, grafted rooted cuttings, unrooted grafted cuttings, plant cell, tissue culture, meristem, flowers and any other vegetative or reproductive part of the plant.

It is a further object of the present invention to disclose high stem grafted propagation material produced by the method as defined in any of the above, wherein said propagation material is selected from the group consisting of high stem grafted young plants, high stem grafted rooted cuttings, high stem grafted unrooted cuttings and high stem grafted seedlings.

It is a further object of the present invention to disclose the method as defined in any of the above, further comprises steps of selecting herbaceous rootstock compatible with said herbaceous scion.

It is a further object of the present invention to disclose the method as defined in any of the above, further comprises steps of engrafting said rootstock with at least two different scions, said scions belong to different varieties and are compatible with said rootstock.

It is a further object of the present invention to disclose the method as defined in any of the above, further comprises steps of providing said different scions having at least one different characteristic selected from the group consisting of: inflorescence color, fruit shape, growth pattern and any combination thereof.

It is a further object of the present invention to disclose the method as defined in any of the above, comprising additional steps of producing and growing high stem grafted propagation material selected from the group consisting of high stem grafted young plants and high stem grafted unrooted raw material at predetermined growth conditions so as to provide said high stem grafted plant.

It is a further object of the present invention to disclose the method as defined in any of the above, further comprises steps of selecting said young plants from the group consisting of rooted cuttings, seedlings, high stem grafted rooted cuttings, and grafted seedlings.

It is a further object of the present invention to disclose the method as defined in any of the above, further comprises steps of selecting said unrooted raw material from the group consisting of unrooted cuttings and high stem grafted unrooted cuttings.

It is a further object of the present invention to disclose the method as defined in any of the above, further comprises steps of growing said unrooted raw material in plug trays.

It is a further object of the present invention to disclose the method as defined in any of the above, further comprises steps of growing said propagation material so as to produce a finished grafted high stem plant.

It is a further object of the present invention to disclose a method of producing a herbaceous grafted scion free of soil borne disease comprising the steps of: (a) providing a herbaceous scion plant; (b) selecting a rootstock which is compatible with said scion; (c) growing said rootstock under predetermined agrotechnical conditions so as to produce a rootstock with a predetermined stem height of at least 7 cm and growth characteristics suitable for grafting with said scion; (d) growing said scion plant under agrotechnical conditions, so as to provide a scion with growth characteristics suitable for grafting with said rootstock; and (e) grafting said scion onto said rootstock at said predetermined stem height of at least 7 cm; thereby producing a high stem grafted herbaceous scion free of soil borne diseases.

### BRIEF DESCRIPTION OF THE DRAWINGS

In order to understand the invention and to see how it may be implemented in practice, several embodiments will now be described, by way of non-limiting example only, with reference to the accompanying drawing, in which:

FIG. 1 presents a photographic illustration of an ornamental pepper cultivar ‘Medusa’ in it's non-grafted, natural growth habit (100) and after grafting on a high stem rootstock (200) as an embodiment of the present invention;

FIG. 2 presents a photographic illustration of an ornamental pepper cultivar ‘Treasures Red’ in it's non-grafted, natural growth habit (300) and after grafting on a high stem rootstock (400) as an embodiment of the present invention;

FIG. 3 presents a photographic illustration of an ornamental pepper cultivar grafted on a high stem rootstock as an alternative embodiment of the present invention;

FIG. 4 presents a photographic illustration of a high stem grafted ornamental pepper plug plant;

FIG. 5 presents a photographic illustration of a plurality of high stem grafted ornamental pepper plants planted in pots as compared to a corresponding non-grafted ornamental pepper plant (500);

FIG. 6 presents a photographic illustration of different growth phases of Ocimum kilimandscharicum×O. basilicum F1 ‘Magic Mountain’™ rootstock (A-C) and a high stem grafted plug plant comprising the Ocimum kilimandscharicum×O. basilicum F1 ‘Magic Mountain’™ rootstock engrafted with Ocimum basilicum var. minimum ‘el-Greco’ variety scion (D);

FIG. 7 presents a photographic illustration of a mature engrafted high stem Ocimum basilicum var. minimum plant planted in a pot;

FIG. 8 presents a photographic illustration of high stem grafted Calibrachoa plant, grown for two months under greenhouse conditions;

FIG. 9A presents a photographic illustration of high rooting potential of Petunia rootstocks according to some embodiments of the present invention;

FIG. 9B presents stretched or elongated Petunia rootstock according to some embodiments of the present invention;

FIG. 10 photographically illustrating callus formation, rooting and the undesirable phenomena of sprouts growth from the callus of a Calibrachoa sp. grafted upon Petunia rootstocks;

FIG. 11 photographically illustrating growth of sprouts from callus of a Calibrachoa sp. grafted upon Petunia rootstocks;

FIG. 12 photographically illustrating different rootstock trunk development and thickness;

FIG. 13 photographically illustrating incompatibility between the rootstocks Petunia sp. ‘Crazytunia’ models Mandeville and Stone-was, and the scions Calibrachoa sp. ‘Chameleon’ models Pink and Purple;

FIG. 14 presents a photographic illustration of grafting point breakdown of Calibrachoa sp. ‘Chameleon’ pink grafted upon Petunia surfinia pink;

FIG. 15A presents a photographic illustration of Ocimum basilicum var. minimum ‘el Greco’ plant, used as a scion;

FIG. 15B presents a photographic illustration of Ocimum kilimandscharicum×O. basilicum F1 ‘Magic Mountain’™ plant, used as a rootstock;

FIG. 15C presents a photographic illustration of high stem grafted basil seedling;

FIG. 15D presents a photographic illustration of high stem grafted basil in different growth stages of 1, 4, 14 and 40 weeks old, from right to left, respectively;

FIG. 16A presents a photographic illustration of high stem grafted tomato plant comprising ‘Ikram’ scion grafted on ‘Arnold’ rootstock;

FIG. 16B presents a photographic illustration of rootstock preparation for grafting at first leaf height;

FIG. 16C presents a photographic illustration of grafting of ‘TT33’ tomato variety as a scion on different rootstocks (left to right) ‘Resistar’, ‘Bufor’ and ‘Arnold’, respectively;

FIG. 16D presents a photographic illustration of high stem grafted tomato comprising ‘TT33’ scion grafted on different rootstocks, compared to non-grafted ‘TT33’ tomato variety;

FIG. 16E presents a photographic illustration of ‘TT33’ tomato variety scion grafted on ‘Resistar’ rootstock;

FIG. 16F presents a photographic illustration of ‘TT33’ scion grafted on different rootstocks, from left to right, ‘Arnold’, ‘Bufor’ and ‘Resistar’, respectively;

FIG. 16G presents a photographic illustration of the effect on root system development, of grafting ‘TT33’ scion on different rootstocks; from left to right, ‘TT33’ scion grafted on ‘Arnold’ rootstock, non-grafted ‘TT33’ plant; ‘TT33’ scion grafted on ‘Resistar’ rootstock;

FIG. 16H presents a photographic illustration of a high stem grafted tomato plant according to an embodiment of the present invention;

FIG. 16I presents a photographic illustration of a high stem grafted tomato plant comprising Tomate Ponchi™-Re F1 as a scion, grafted on ‘Resistar’ rootstock, as an alternative embodiment of the present invention;

FIG. 16J presents a photographic illustration of a high stem grafted tomato plant, according to some embodiments of the present invention. Right: Tomate Ponchi™-Re F1 grafted on submarine 001 rootstock; Left Dwarf tomato ‘TT33’ grafted on ‘Resistar’ rootstock;

FIG. 16K presents a photographic illustration of a non-grafted dwarf tomato commercial product in a pot, as a comparison to the grafted high stem dwarf tomato plant of the present invention;

FIG. 17A shows on the left—non-grafted Capsicum ornamental ‘Treasurs’, and on the right—high stem grafted Capsicum ornamental ‘Mambo™’ on Capsicum ‘Maccabi’ rootstock;

FIG. 17B shows a photographic illustration of different models of grafted Capsicum ornamental ‘Mambo™’ on Capsicum ‘Maccabi’ rootstock;

FIG. 17C shows a photographic illustration of Capsicum ornamental ‘Mambo™’ grafted on Capsicum ‘Maccabi’ rootstock;

FIG. 17D shows a photographic illustration of Capsicum ornamental ‘Medusa’ grafted on Capsicum ‘Maccabi’ rootstock;

FIG. 17E shows a photographic illustration of seedling specifications (left and right sides of the figure) of grafted Capsicum ornamental ‘Medusa’ on Capsicum ‘Maccabi’ rootstock;

FIG. 18A presents a photographic illustration of high stem grafted Origanum vulgare;

FIG. 18B presents a photographic illustration of some embodiments of the high stem grafted Origanum of the present invention: Left—grafted rooted Origanum vulgare (short stem), Right—high stem grafted Origanum ‘Aureum Variegata’ on Majorana syriaca Za'atar rootstock; and

FIG. 18C presents a photographic illustration of high stem rootstock test of Majorana syriaca Za'atar, grafted on itself.

### DETAILED DESCRIPTION OF THE PREFERRED EMBODIMENTS

The following description is provided, alongside all chapters of the present invention, so that to enable any person skilled in the art to make use of the invention and sets forth the best modes contemplated by the inventor of carrying out this invention. Various modifications, however, will remain apparent to those skilled in the art, since the generic principles of the present invention have been defined specifically to provide means and methods for producing high stem grafted herbaceous plants and products thereof.

In one embodiment, the present invention provides high stem grafted plants and more preferably, high stem grafted herbaceous plants.

In another embodiment, the present invention provides high stem grafted herbaceous propagation material such as high stem grafted herbaceous young plants and high stem grafted herbaceous unrooted raw material to be transplanted by finishers into pots or planting containers for further growth and thereafter delivered to retailers to be sold on to the consumers.

There is a commercial need to produce new ornamental and esthetic combinations by grafting herbaceous, vegetable and flowering plants having a short height or shrubby or bushy growth habit on a high stock or stem, which is met and achieved by the present invention. Up until now such plants were grafted at a maximum height of about 2-5 cm above the ground.

Currently high stem plants are produced by a cumbersome and inefficient method based on leaving the chosen plant to grow to the desired height and frequently clipping off the side shoots that develop on the trunk. The present invention was developed in order to provide a more efficient and robust method for production of high stem plants.

The present invention discloses a novel and effective approach by introducing for the first time high stem herbaceous plants produced by grafting techniques and methods. By using the technique of the present invention to produce high stem grafted herbaceous plants, the costs involved are sharply reduced and the production process is simplified, saves time and manual work.

In some embodiments, the present invention enables the provision of enhanced height grafted plant with enhanced stem thickness and new crown configuration. These desirable characteristics are derived from the grafting process of the present invention and the directed interactions between the scion and the rootstock. These qualities cannot be obtained by conventional growth of the scion variety on single branch as a stem, i.e. by stretching technique.

The present invention enables for the first time the opportunity to produce a significantly wide range of herbaceous plant species, varieties and combinations that can be grown as high stem plants.

Moreover, by the use of grafting, one produces not only nicer more desirable and unique plants but also higher survivability, and improved performance, as an added value for the consumer and higher returns to the producer.

In fact, the use of grafting as an upscale method for production of high stem plants provides a brand new product of high ornamental plants in small pots (containing from 0.1 liter to 2 liter of growing medium i.e. soil. As of today high stem plants are sold to consumers in relatively large pots (2 liter and up by volume).

Some of the advantages of the high stem grafted plants of the present invention may include:

Precocity: The ability to induce fruitfulness without the need for completing the juvenile phase, which is the natural state through which a seedling plant must pass before it can become reproductive. In most fruiting trees, juvenility may last between 5 and 9 years and up to 15 years. Grafting of mature scions onto rootstocks can result in fruiting in about two years.

Dwarfing: To induce dwarfing or cold tolerance or other characteristics to the scion.

Ease of propagation: when the scion is difficult to propagate vegetatively by other means, such as by cuttings, for example because of rooting difficulty or cuttings production difficulty of the selected scion. In this case, cuttings of an easily rooted plant are used as a rootstock to be grafted with the selected scion.

Hybrid breeding: To speed maturity of hybrids, especially in fruit tree breeding programs. Hybrid seedlings may take ten or more years to flower and fruit on their own roots. Grafting can reduce the time to flowering and shorten the breeding program.

Hardiness: When the scion has weak roots or the roots of the stock plants have roots tolerant of difficult conditions.

Sturdiness: To provide a strong, tall trunk for ornamental shrubs and trees. In these cases, a graft is made at a desired height on a stock plant with a strong stem. This is used by the present invention to raise ‘standard’ herbaceous plants, on a high stem.

Disease/Pest Resistance: In areas where soil-borne pests or pathogens would prevent the successful planting of the desired cultivar, the use of pest/disease tolerant rootstocks allows the production of the desired cultivar.

Changing cultivars: To change the cultivar to a more profitable or commercially desirable cultivar, also called top working. It may be faster to graft a new cultivar onto an established rootstock than to replant or develop an entire plant.

Maintain consistency: consistency, a desirable property in the commercial farming industry, is herein maintained by grafting a scion with desired fruit traits onto a hardy stock.

It is further noted that such high stem grafted plants provided by the present invention are desirable and advantageous by having properties such as desirable ornamental or esthetic design, enhanced height or high stem plant, sturdiness, strong root system, tolerance to biotic stress, tolerance to abiotic stress, tolerance to soil borne pathogens and diseases, uniformity, reduced leaf yellowing, robust growth, plant vigor, vigorous growth, enhanced inflorescence yield, enhanced yield of plant propagation material such as cuttings, enhanced aerial yield, combination of more than one species or variety on one plant and any combination thereof.

Moreover, the high stem grafted plants of the present invention are advantageous since they allow: the use of herbicides as the scion or crown part of the plant is elevated above the ground, training the plant quickly and easily, simplification of pruning and shaping the plants, avoidance of new root development from the upper parts of the plant (i.e. development of secondary roots), limitation of pruning wounds and elimination of protective nets against rodents.

It is further noted that herbaceous plants are known for their relatively weak root system and are rather susceptible to various soil and water qualities. The present invention discloses for the first time the grafting of herbaceous scion on a selected compatible rootstock, grown under agrotechnical conditions to have a high stem of at least 7 cm. The selected rootstock preferably has desirable horticultural and ornamental characteristics such as at least one of the following novel characteristics: elevated stem, strong root system, vigorous growth and tolerance to biotic and/or abiotic stresses. Thus a new and surprising commercially valuable high stem engrafted plant, preferably herbaceous plant, is provided.

The production and provision of the grafted high stem herbaceous plants of the present invention enable the achievement of unique and innovative ornamental and horticultural combinations, for example, enhanced height Basil, enhanced height ornamental pepper and enhanced height Calibrachoa grafted plants as compared to the currently available shrubby-type plants. In further aspects, high stem grafted herbaceous plants with desirable added value such as heat, alkalinity and salt tolerance as compared to the currently available weak and sensitive herbaceous plant varieties and cultivars are produced and provided by the present invention. According to other embodiments, uniquely designed engrafted high stem plants and new combinations of herbaceous plant species and/or varieties within one plant are herein provided.

The present invention comprises the following novel and unexpected merits:
1. The creation and provision of high stem grafted herbaceous plants;
2. The creation and provision of high stem grafted propagation material in the form of young plants or in the form of unrooted raw material adapted for planting in plug trays.

Furthermore, the present invention provides high stem grafted source plants or mother plants which produce a higher yield of cuttings and therefore increase the efficiency of the cutting yield.

In accordance with a further embodiment, the present invention provides novel high stem grafted propagation material in the form of young plants or any other raw material which is used by growers to produce and develop the finished grafted product, preferably high stem grafted herbaceous plant, and sell it on to retailers or end users.

It is within the scope of the present invention to provide high stem grafted propagation material such as young plants or unrooted raw material that is used to produce flowering pots of high stem grafted plants and preferably high stem grafted herbaceous plants. Such propagation material encompass, for example, (1) young plants comprising rooted cuttings, seedlings, high stem grafted rooted cuttings and high stem grafted seedlings, and (2) unrooted raw material or propagation material comprising unrooted cuttings and high stem grafted unrooted cuttings. The unrooted, high stem grafted propagation material may be inserted into plug trays for the development of roots and thereafter transplanted by finishers into pots or planting containers for further growth and thereafter delivered to retailers to be sold on to the consumers.

Thus according to a further embodiment, a finished high stem grafted plant is produced from the propagation material in the form of young plants or other forms of raw material and is provided by the present invention.

In further aspects, the high stem grafted plants, preferably high stem grafted herbaceous plants provided by the present invention is adapted for perpendicular stability and/or sturdiness when planted in a pot or planting containers. The high stem grafted herbaceous plant has desirable properties such as vigorous growth and strong stem and root system, which enable its sturdiness and perpendicular stability when planted and grown in a pot.

In a further embodiment, high stem grafted herbaceous propagation material in the form of young plants or in the form of unrooted raw material is provided by the present invention for the first time. The high stem grafted herbaceous unrooted raw material, e.g. unrooted cuttings, are adapted for insertion and development of roots in plug trays. Once rooted, the high stem grafted herbaceous young plants are ready for transplanting to pots or planting containers for finishing off.

Furthermore, the invention facilitates production and supply of unrooted grafted cuttings for the production of high stem grafted young plants.

It should be emphasized that unrooted grafted cuttings of various plants' genus are produced and sold, but no high stem grafted (or not grafted) unrooted cuttings are exist in the prior art, for example high stem grafted unrooted cuttings of herbaceous plants. Such high stem unrooted grafted cuttings are, for the first time, surprisingly provided by the present invention and are capable of being embedded, planted in pots or rooted in plug trays, sturdily and/or perpendicularly stably grown in the plug trays and sold for on to finishers to be planted in pots, in growing containers or in flower beds.

It is further noted that there are grafted young plants, produced and sold in the prior art, but no high stem (grafted or not) young plants, for example high stem grafted young plants of herbaceous plant. Such high stem grafted young plants, are, for the first time, surprisingly provided by the present invention.

The aforementioned herbaceous young plants can be produced from grafted or not, cuttings or seedlings and are sold or provided to finishers to be transplanted to pots or planting containers.

### Definitions

The term “engrafted plant” or “grafted plant” as used hereinafter generally refers to a plant comprising a rootstock and at least one scion, wherein the scion(s) is (are) grafted onto the rootstock by any method known in the art.

As used herein, the term “rootstock” as used hereinafter refers to part of a plant comprising the stem and/or underground part or rooting system of that plant and onto which a scion, cutting or bud is intended to be grafted. According to some embodiments it can refer to a rhizome or stem. The rootstock is generally selected for its characteristics including, interaction with the soil, providing the roots and the stem to support the new plant, obtaining water and minerals from the soil, and providing resistance or tolerance to the relevant pests, diseases and/or other stress such as heat and salt tolerance.

It is further within the scope that the rootstock may be chosen by a person skilled in the art for its rooting characteristics, its disease resistances and for the vigor it can confer to the engrafted plant. According to one embodiment, the rootstock of the plant of the present invention may be selected by its compatibility characteristics with the scion, which in some embodiments is herbaceous scion. In certain aspects, the rootstock is manipulated to have a predetermined height, preferably at least 7 cm, upon which the scion is engrafted.

The term “scion” as used hereinafter refers to the plant part grafted onto the rootstock. The scion usually comprises the stem part or aerial parts (leaves, flowers, fruits) of another plant. The scion is selected for it's properties such as the photosynthetic activity and the fruit or decorative properties. In some embodiments, herbaceous scion is selected.

It is within the scope that the term scion also means “crown”. The crown of a plant refers to the totality of the plant's aboveground parts, including stems, leaves, and reproductive structures. A plant canopy consists of one or more plant crowns growing in a given area.

The term “high stem” used herein, is to be understood in its common meaning in horticulture, namely an elongated stem or trunk of a plant bearing a “crown” on its top end. The crown of a plant refers to the plant's aboveground parts, including stems, leaves, and reproductive structures.

The term “high stem grafted plant” used hereinafter refers to a rootstock grown in predetermined agrotechnical conditions designed to produce an elevated stem of at least 7 cm up to the first node, particularly up to 50 cm or more, more particularly between about 10 cm and 30 cm, upon which a scion is engrafted. In other embodiments, the dimensions of the crown of the high stem grafted plant are at least about 7 cm and up to 30 cm. In preferred embodiments ‘high stem grafted herbaceous plants’ are provided by the present invention. Such a ‘high stem grafted herbaceous plant’ comprises herbaceous scion engrafted upon a compatible rootstock at predetermined height of at least 7 cm. In some aspects such ‘high stem grafted herbaceous plant’ comprises herbaceous scion engrafted upon a compatible herbaceous rootstock at predetermined height of at least 7 cm. The resultant grafted herbaceous plant is advantageous as compared to a corresponding non-grafted normal plant, for example, by its enhanced stem height, vigorous growth, strong root system, fruit yield characteristics and tolerance or resistance to biotic and abiotic stresses. Furthermore, grafting a scion upon an enhanced height rootstock according to the method of the present invention has the advantage of prevention of contaminants penetration to scion e.g. foliage, fruits, vegetables, which may result in reduced use of toxic chemicals. In general, a corresponding non-grafted scion plant is usually characterized by undesirable horticultural properties such as a relatively weak root system, susceptibility to alkaline surroundings or other abiotic stresses, susceptibility to contaminants and/or pathogens and/or pests (including insects, fungi, bacteria, viruses and parasitic weeds). The high stem grafted herbaceous plant can be produced from rooted or unrooted cuttings or from seedlings, and includes high stem grafted propagation material or raw material.

The term “herbaceous plant” as used herein generally refers to a plant lacking a persistent woody stem above the ground. Such plants have leaves and stems that die down at the end of the growing season to the soil level. Herbaceous plants may be annuals, biennials or perennials. Some of the herbaceous plants are flowering garden plants or potherbs; some having medicinal properties and some are weeds. In the context of the present invention herbaceous plants include flowering plants, vegetables and herbs.

The term “source plant” or “mother plant” is herein defined as the initial grafting of a scion onto the rootstock in order to produce the “crop” of cuttings. Typically the source plant therefore should provide a large amount of vigorous cuttings which are subsequently used for future grafting or grown directly on their own root system.

The term “compatibility” as used hereinafter, is defined as a sufficiently close genetic (taxonomic) relationship between stock and scion for a successful graft union to form, assuming that all other factors and parameters (technique, temperature, etc.) are satisfactory. It is herein further submitted that the degree of “relatedness” necessary for compatibility may vary with different taxa (species, genera, and families).

It is further within the scope of the invention, that the term “incompatibility” may herein be defined as failure (immediate or delayed) of a graft union to form. Incompatibility or failure of the graft to form may occur due to insufficiently close genetic relationship between the stock and scion, due to the grafting technique, cellular physiological intolerance that may be caused by metabolic, developmental and/or anatomical differences between stock and scion, failure to form functional vascular connections between stock and scion non-optimal environment, or disease such as viral disease, introduced as a result of grafting.

It is further within the scope that the term “immediate incompatibility” is herein defined as the rapid death of the scion characterized anatomically by lack or incomplete progression of graft union formation. Early events in normal graft union formation may include callus formation and formation of fibers.

The term “delayed incompatibility” refers to survival or normal growth of the grafted scion for months or even years, including normal formation of xylem, phloem and periderm, before degeneration of the graft union occurs.

In general, the compatibility between the scion and the selected rootstock may be affected by the plant species, type of graft and environmental conditions following grafting. Such conditions may include temperature, which effects callus production, moisture, which effects cell enlargement in the callus bridge, growth pattern of the rootstock and virus contamination, insects and diseases.

It is herein acknowledged that the formation of a graft union requires the development of a de novo formed meristematic area between the scion and the rootstock. According to some aspects, this process may comprise steps of: adhesion of the rootstock and the scion; proliferation of the callus at the interface and forming a callus bridge; and vascular differentiation across the graft interface.

The term “propagation material” or “grafted propagation material” or “high stem grafted propagation material” or “high stem grafted herbaceous propagation material” is herein refers to any raw material that is used for the creation of new plants by grafting. The propagation material or raw material encompasses seeds, all plant material or vegetative parts of plants intended for the production of the grafted plants. It is within the context of the present invention that such propagation material includes (1) rooted grafted propagation material e.g. young plants, and (2) unrooted grafted raw material or propagation material e.g. unrooted cuttings. The rooted and unrooted propagation material is used by growers to produce and develop the finished high stem grafted plant product.

The term “young plant” or “herbaceous young plant” is herein defined as rooted propagation material comprising members of the following: rooted cuttings, seedlings, high stem grafted rooted cuttings, and high stem grafted seedlings. In a specific embodiment, young plant refers to a small, young age plant with an active root system. The young plants as defined above can be planted and grown in any container, such as planting containers, pots, planters or flower beds. According to certain aspects, it is considered as an advanced level grafted propagation material, or, in other words it is considered as the most developed grafted raw material that finishers use, i.e. pot plant producers, growers that plant them in the field or in commercial planters or plantation, who grow them till harvesting stage. Young plant producers might graft the young plants whilst in the plug trays.

The term “unrooted propagation material” or “unrooted raw material” or “unrooted herbaceous propagation material” or “unrooted herbaceous raw material” is herein defined as comprising members of the following: unrooted cuttings and high stem grafted unrooted cuttings. It is within the scope of the present invention that such unrooted propagation material can be planted and grown in any growing container, but mostly grown in plug trays for the development of roots and thereafter may be transplanted by finishers into pots or planting containers for further growth and optionally thereafter delivered to retailers to be sold on to the consumers.

The present invention provides novel high stem grafted propagation material in the form of young plants or unrooted grafted raw material that is transported to its final position within a growing container or plantation to achieve a finished plant.

Furthermore, by using the grafting method of the present invention, high ornamental plants, and preferably high herbaceous plants, in small pots (containing from 0.1 L to 2 L of growing medium) are produced.

The term “finished plant” is herein defined as a high stem grafted herbaceous plant in its final size, shape and design, suitable for marketing to the late stage in the supply chain such as end user or florists.

It is further within the scope of the present invention to provide novel high stem grafted herbaceous propagation material or raw material. Such high stem grafted propagation material comprises (1) high stem grafted young plants e.g. in the form of rooted cuttings, seedlings, grafted rooted cuttings, and grafted seedlings and (2) high stem grafted unrooted raw material e.g. in the form of unrooted cuttings and unrooted grafted cuttings.

It is according to a further embodiment that new propagation material comprising high stem grafted herbaceous young plants and high stem grafted herbaceous unrooted raw material is produced by the grafting method of the present invention and is an embodiment of the present invention.

In certain aspects, the present invention provides propagation material products, such as high stem grafted herbaceous young plants and high stem grafted herbaceous unrooted raw material in plug trays.

According to a further aspect, the present invention provides plugs of high stem grafted unrooted propagation material or raw material, preferably, high stem grafted herbaceous unrooted propagation material or raw material. The term “plug” or “plug tray” generally refers in horticulture to small-sized seedlings or cuttings grown in trays, filled usually with a peat or compost substrate. This type of plug may generally be used for commercially raising vegetables, ornamental plants and bedding plants. Plug plants are unrooted young plants raised in small, individual cells, for the development of roots, ready to be transplanted into containers, pots or a garden or fields.

It is within the context of the present invention to provide high stem grafted herbaceous propagation material in the form of young plants and high-stem grafted herbaceous propagation material in the form of unrooted raw material that is adapted to be inserted or rooted in plug trays. The unrooted grafted propagation material is adapted to be sturdily, perpendicularly and stably grown in the plug trays until transplanted (e.g. by finishers) into pots or growing containers or any final commercial planter.

Thus the present invention provides high ornamental grafted plants, and preferably high herbaceous grafted plants, in small pots (containing from 0.1 L to 2 L of growing medium).

The term “sturdily grown” or “sturdiness” as used in the context of the present invention refers to the provision of a strong, tall stem or trunk for certain herbaceous plants, ornamental shrubs and trees. It is herein acknowledged that a graft is made at a desired height on a stock plant, with a strong stem. This is used to raise plants, usually ornamental plants with a shrubby or bushy or herbaceous growth habit, on a high stem to produce a new combination. It is further within the scope that sturdiness refers to the provision of a strong, tall trunk for certain ornamental, herbaceous plants, shrubs and trees. In these cases, a graft is made at a desired height on a stock plant with a strong stem. This is used to raise such bushes or herbaceous plants or some ornamental plants on a high stem.

The term “cutting” or “cuttings” as used herein refers to vegetative or asexual propagating plant material. Plant cuttings are used for vegetative (asexually) propagation of plants, by a technique in which a piece of the stem, leaves or root of the source plant is placed in a suitable medium such as moist soil, potting mix, coir or rock wool. The plant piece (called cutting) produces new roots, stems, or both, and thus becomes a new plant independent of the parent or source plant. Plant cutting technique is also known as striking or cloning technique. In the context of the present invention, the term “cutting” or “cuttings” include rooted cuttings, unrooted cuttings, grafted rooted cuttings and grafted unrooted cuttings.

The term “unrooted cutting” refers to cuttings that have no roots and must be inserted in the plug tray medium (the soil) and take root there.

The term “seedlings” as used herein refers to a young plant developing from a seed and includes seedlings and grafted seedlings.

In the context of the present invention, the term “variety” or “varieties” correspond to the usual denomination in agricultural industry and correspond to a plant of a given botanical taxon which is distinct from other existing plant, which is uniform and stable.

The term “normal plant” used hereinafter refers to an ungrafted or non-grafted plant (e.g. herbaceous plant) in its natural growth form.

The term “etiolated plant” or “etiolating plants” used hereinafter refers to plants grown in partial or complete absence of light. These plants are generally characterized by elongated stems; longer internodes, hence usually fewer leaves per unit length of stem and a pale yellow color (chlorosis). According to one embodiment, the selected rootstock plants of the present invention are grown under low radiation conditions that enhance the production of etiolated plants.

The term “ornamental pepper” used herein after generally refers to a shrubby type, Capsicum annuum varieties producing colorful and relatively small fruits. Most varieties are bred for ornamental use. The pepper fruits may be cone-shaped or round, depending on the variety. Furthermore, depending on the variety, the peppers appear in shades of white, purple, red, orange, and yellow or with multiple colors on the same plant. In other embodiments, the peppers change colors as they mature, for example, from green to yellow to orange to red. Some varieties have purple fruit that is almost black. The peppers are edible, and may be sweet or hot.

Non-limiting examples of ornamental pepper varieties or cultivars used for producing the high stem grafted herbaceous plants of the present invention may include Conic Hot pepper varieties such as ‘Mambo Purple Orange’, ‘Mambo Purple Red’ and ‘Mambo Yellow Red’; Sweet pepper varieties such as ‘Sangria’ pepper, ‘Medusa’ pepper and ‘Peppa Purple Tangerine’; Cascade Hot pepper varieties such as ‘Cubana Multicolor Red’, ‘Cubana Multicolor Orange’ and ‘Cubana Deep Orange’; ‘Black Pearl’ pepper; ‘Calico’ pepper; ‘Chilly Chili’ pepper; ‘NuMex Twilight’ pepper; ‘Pretty in Purple’ pepper; ‘Purple Flash’ pepper and ‘Treasures Red’.

In general, Capsicum varieties and cultivars included within the scope of the present invention and used for producing the scion and/or rootstock of the high stem grafted herbaceous plants may be members of the following:

(1) C. annuum var. annuum such as ‘Aleppo’, ‘Anaheim’, ‘Ancho’, ‘Banana’ pepper, ‘Bell’ pepper, ‘Bird's eye’, ‘Cascabel’, ‘Cayenne’, ‘Chilaca’, ‘Chungyang red’ pepper, ‘Cubanelle’, ‘Chile de arbol’, ‘Dundicut’, ‘Facing heaven’, ‘Fresno’, ‘Guajillo’, ‘Hungarian wax’, ‘Italian sweet’, ‘Jalapeno’, ‘Medusa’, ‘Mulato’, ‘New Mexico’ (‘Anaheim’), ‘Padrón’, ‘Pasilla’, ‘Peperoncini’, ‘Peter’, ‘Pimento’, ‘Poblano’, ‘Santa Fe Grande’, ‘Serrano’, ‘Shishito’, ‘jalapenos’, ‘ancho/poblanos’.

(2) C. annuum var. glabriusculum such as ‘Piquín’ and ‘Wild chiltepin’.

(3) C. chinense such as ‘Adjuma’, ‘Ají dulce’, ‘Carolina Reaper’, ‘Datil’, ‘Fatalii’, ‘Habanero’, ‘Hainan yellow lantern chili’, ‘Madame Jeanette’, ‘Naga jolokia’, ‘Red Savina’ habanero, ‘Scotch bonnet’, ‘Trinidad moruga scorpion’, ‘Trinidad scorpion’ and ‘Butch T’.

(4) C. frutescens such as ‘African bird's eye’, ‘Siling labuyo’, ‘Malagueta’ and ‘Tabasco’.

(5) C. baccatum such as ‘Ají’, ‘Bishop's crown’, ‘Lemon drop’ and ‘Peppadew’; and

(6) C. pubescens such as ‘Rocoto’ pepper, ‘Canario’, ‘Manzano’ and ‘Locoto’.

According to one embodiment, the present invention surprisingly provides for the first time a high stem grafted herbaceous plant. The grafted plant comprises a scion engrafted upon a rootstock at a predetermined height of at least 7 cm. In preferred embodiments, the selected rootstock is herbaceous plant which is compatible with the scion.

According to a further embodiment the high stem grafted herbaceous plant is obtained by grafting any herbaceous scion with any compatible rootstock, provided they are compatible in terms of grafting-ability, and that the selected rootstock provides predetermined desirable characteristics such as strong root system, high yield, vigorous growth, tolerance to at least one biotic and/or abiotic stress and/or enhanced stem height.

According to certain aspects of the present invention, the selected scion and/or rootstock is herbaceous-type plant.

The high stem grafted herbaceous plant of the present invention may be derived from propagation material or raw material comprising members of the following: young plants, namely rooted cuttings, seedlings, high stem grafted rooted cuttings and high stem grafted seedlings, or from unrooted propagation material or raw material comprising members of the following: unrooted cuttings and high stem grafted unrooted cuttings. Thus the present invention provides young plants or any other propagation material or raw material comprising rooted cuttings, unrooted cuttings, seedlings, high stem grafted rooted cuttings, high stem grafted unrooted cuttings and high stem grafted seedlings useful for producing high stem grafted plants, and particularly high stem grafted herbaceous plants.

In certain embodiments, the rootstock and/or scion can be selected from the group comprising Solanaceae, Lamiaceae (or Labiatae), Lobeliaceae, Asteraceae, Scrophulariaceae, Caryophyllaceae, Cucurbitacea family, and any combination thereof.

In certain embodiments, the rootstock and/or scion can be selected from the group comprising Solanum, Capsicum, Ocimum, Petunia, Physalis and Calibrachoa genus and any combination thereof.

The present invention further encompasses plants comprising a rootstock engrafted with at least two different scions belonging to two different species or varieties.

It is to be understood that the invention is not limited to the examples described herein, but it should be considered with any sorts of compatible rootstocks and scions, and for any sorts of grafting methods. Thus, the invention is capable of other embodiments carried out in various ways.

In one embodiment, the present invention discloses means and methods for grafting between genera within the same family.

According to a further embodiment, the present invention discloses means and methods for grafting between species within a genus.

Accordingly, the herbaceous engrafted plant according to the present invention can comprise a Solanaceae rootstock variety or cultivar. These rootstock varieties or cultivars may be any type of the Solanaceae family, provided they are compatible for grafting with the scion.

In a further embodiment, the high stem grafted herbaceous plant according to the present invention comprises at least two scions engrafted on a compatible rootstock.

It is herein acknowledged that the method of the present invention enables a wide variety of high stem herbaceous plants to be grafted, of different growing habits. Growth habits of plants are classified differently, but in a non-limiting way, we refer to the USDA definitions as follows;

| PLANTS | | | |
|---|---|---|---|
| Growth | | | |
| Habit | PLANTS | | |
| Code | Description | PLANTS Definition | Notes |
| FB | Forb/herb | Vascular plant without | Applies to vascular plants |
| | | significant woody tissue above | only. Federal Geographic |
| | | or at the ground. Forbs and | Data Committee (FGDC) |
| | | herbs may be annual, biennial, | definition includes |
| | | or perennial but always lack | graminoids, forbs, and |
| | | significant thickening by | ferns. |
| | | secondary woody growth and | |
| | | have perennating buds borne at | |
| | | or below the ground surface. In | |
| | | PLANTS, graminoids are | |
| | | excluded but ferns, horsetails, | |
| | | lycopods, and whisk-ferns are | |
| | | included. | |
| GR | Graminoid | Grass or grass-like plant, | Applies to vascular plants |
| | | including grasses (Poaceae), | only. An herb in the FGDC |
| | | sedges (Cyperaceae), rushes | classification. |
| | | (Juncaceae), arrow-grasses | |
| | | (Juncaginaceae), and quillworts | |
| | | (Isoetes). | |
| LC | Lichenous | Organism generally recognized | Applies to lichens only, |
| | | as a single “plant” that consists | which are not true plants. |
| | | of a fungus and an alga or | |
| | | cyanobacterium living in | |
| | | symbiotic association. Often | |
| | | attached to solid objects such as | |
| | | rocks or living or dead wood | |
| | | rather than soil. | |
| LI | Liana | Climbing plant found in tropical | Applies to vascular plants |
| | | forests with long, woody rope- | only. In PLANTS, |
| | | like stems of anomalous | mutually exclusive with VI |
| | | anatomical structure. | (Vine). A shrub in the |
| | | | FGDC classification. |
| NP | Nonvascular | Nonvascular, terrestrial green | Applies to non-vascular |
| | | plant, including mosses, | plants only; in PLANTS |
| | | hornworts, and liverworts. | system this is groups HN |
| | | Always herbaceous, often | (Hornworts), LV |
| | | attached to solid objects such as | (Liverworts), and MS |
| | | rocks or living or dead wood | (Mosses). |
| | | rather than soil. | |
| SH | Shrub | Perennial, multi-stemmed | Applies to vascular plants |
| | | woody plant that is usually less | only. |
| | | than 4 to 5 meters (13 to 16 | |
| | | feet) in height. Shrubs typically | |
| | | have several stems arising from | |
| | | or near the ground, but may be | |
| | | taller than 5 meters or single- | |
| | | stemmed under certain | |
| | | environmental conditions. | |
| SS | Subshrub | Low-growing shrub usually | Applies to vascular plants |
| | | under 0.5 m (1.5 feet) tall, never | only. A dwarf-shrub in the |
| | | exceeding 1 meter (3 feet) tall at | FGDC classification. |
| | | maturity. | |
| TR | Tree | Perennial, woody plant with a | Applies to vascular plants |
| | | single stem (trunk), normally | only. |
| | | greater than 4 to 5 meters (13 to | |
| | | 16 feet) in height; under certain | |
| | | environmental conditions, some | |
| | | tree species may develop a | |
| | | multi-stemmed or short growth | |
| | | form (less than 4 meters or 13 | |
| | | feet in height). | |
| UN | Unknown | Growth form is unknown. | |
| VI | Vine | Twining/climbing plant with | Applies to vascular plants |
| | | relatively long stems, can be | only. In PLANTS, |
| | | woody or herbaceous. | mutually exclusive with LI |
| | | | (Liana). FGDC |
| | | | classification considers |
| | | | woody vines to be shrubs |
| | | | and herbaceous vines to be |
| | | | herbs. |

It is further acknowledged that for different plants and different growth habits novel ratios of scion length to rootstock, or other parameters such as crown weight, volume and area may be included within the present invention. Such parameters may be defined, in a non-limiting manner, for example by a high stem grafted herbaceous plant comprising:
a. a scion of length X
b. a rootstock of length Y
wherein Y/X≥1.

In other aspects, the subject matter of the present invention further encompass stretched or elongated single branched scion (i.e. at least 6 cm height from grafting point) grafted upon a short or normal rootstock (less than about 7 cm) to produce an enhanced height grafted plant.

Reference is now made to several embodiments showing high stem grafted herbaceous plants produced by the method of the present invention.

It is herein acknowledged that, in some embodiments, rootstocks and scions with similar stem diameters were chosen to increase the grafting success. Other parameters that affect the grafting success may include, in a non-limiting manner members of the following: grafting method, plant height, number of branches, number of leaves and root length, internode number, internode diameter, internode and/or stem color, stem habit (upright or creeping), rootstock and/or scion woodification, and any combination thereof.

Generally speaking, the rootstock part, including the belowground portion of a plant may be chosen for its genetic ability to resist or tolerate soil borne disease. The scion, or above-ground portion of the plant may be chosen based on is ornamental or fruit quality.

It is further within the scope that the high stem grafted herbaceous plants of the present invention may optionally have at least one of the following agronomical advantages:
Disease resistance against soil borne pests, prevention of contaminants in the scion (including foliage, fruits, flowers)
Tolerance to abiotic stresses
Improved water and nutrient uptake
Increased productivity

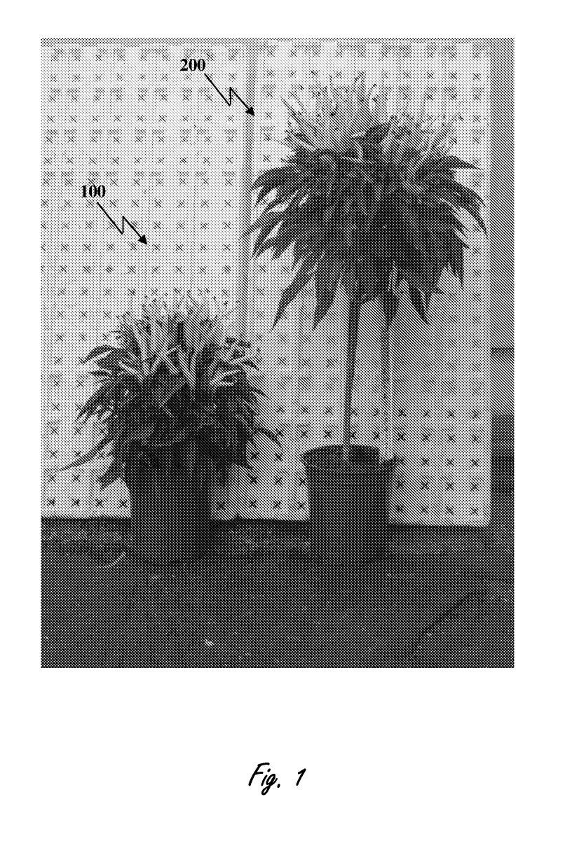

Reference is now made to FIG. 1 presenting a photographic illustration of a non-grafted ornamental pepper cultivar ‘Medusa’, in it's natural growth habit (100) and after grafting on a high stem rootstock (200) as an embodiment of the present invention.

It is herein acknowledged that ‘Medusa’ peppers are a type of sweet, ornamental chili Capsicum annuum pepper which grows upright, brightly colored fruit, which is long and thin, producing a “hair of snakes”-type look. The ‘Medusa’ variety is a dwarf variety (about 6 cm long) bearing non-pungent fruits. It is naturally compact and well-branched, suitable for planting in (10-cm) pot culture. The plants are highly prized in the hobby market and produce colourful, (5 to 5.5-cm) fruit, each with a narrow, twisted, cone shape, held prominently upright over the dark green foliage. The fruit colour changes from green through yellow and orange, to become red when fully ripe. A single plant can produce 40 to 50 fruits, displaying the entire range of colours at one time.

In this embodiment, a rootstock of a Capsicum annuum species has been manipulated and grown under agrotechnical conditions to achieve a predetermined stem or stock height of between about 16 cm and about 20 cm. An ornamental pepper variety ‘Medusa’ (100) has been engrafted upon the aforementioned rootstock at the predetermined height. The high stem grafted plant, which has a new ornamental design and improved horticultural properties (such as resistant to soil-borne pathogens), has been grown for about 60 days in a planting pot to achieve a mature and marketable high stem grafted product (200) for end users.

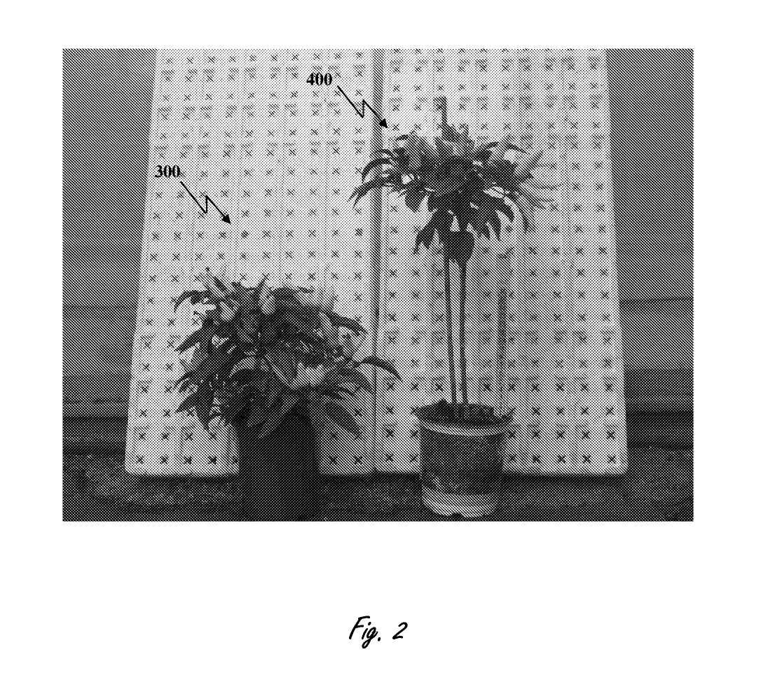

Reference is now made to FIG. 2 presenting a photographic illustration of an ornamental pepper cultivar ‘Treasures Red’, in it's ungrafted, natural growth habit form (300) and after grafting on a high stem rootstock of about 16 cm long (400).

It is herein acknowledged that ‘Treasures Red’ is a Capsicum annuum ornamental pepper cultivar. It has Cluster Type pungent fruits that mature from pale yellow to orange to red and upright pods.

The present invention provides for the first time high stem grafted ornamental pepper, for example, comprising a rootstock of the Capsicum annuum species engrafted with an ornamental pepper crown (i.e. ‘Treasures Red’ ornamental pepper). Thus the methods of the present invention enable the production of new designs and combinations, especially of herbaceous plants, such as elevated grafted ornamental pepper plants.

Furthermore, by using the grafting method of the present invention, high ornamental plants, and preferably high herbaceous plants, in small pots (containing from 0.1 L to 2 L of growing medium) are produced.

The elevated grafted plants are advantageous not only by their esthetic or morphological properties but also for their horticultural traits such as resistant to soil borne pathogens, sturdiness and strong root system.

Reference is now made to FIG. 3 presenting a photographic illustration of a high stem grafted finished plant comprising an ornamental pepper (i.e. ‘Medusa’ cultivar) crown engrafted upon a Capsicum annuum rootstock at a height of about 16 cm.

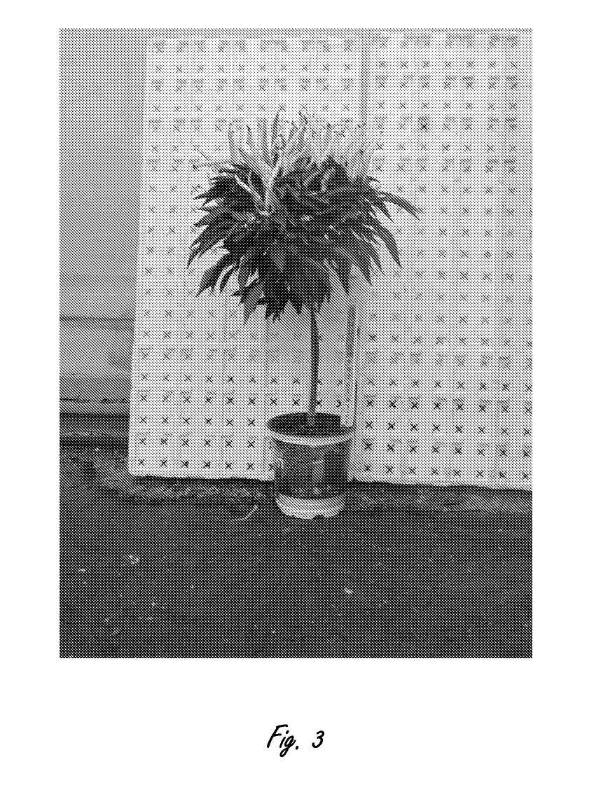

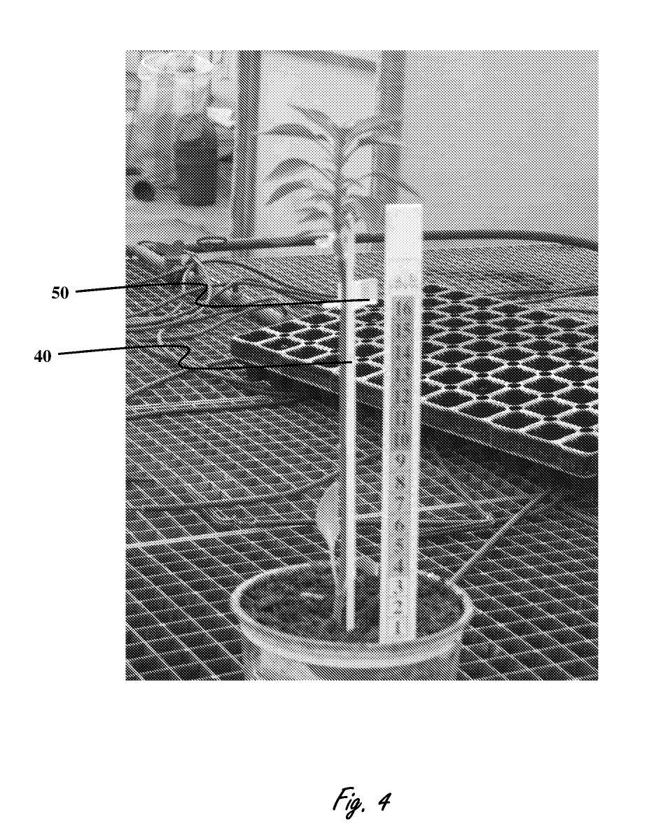

Reference is now made to FIG. 4 presenting a photographic illustration of a high stem grafted plug plant comprising an ornamental pepper cultivar grafted onto a Capsicum annuum rootstock at a height of about 16 cm. The young high stem grafted plug plant is provided as a high stem grafted propagation material to be transplanted by finishers into pots or planting containers for further growth and thereafter delivered to retailers to be sold on to the consumers. As can be seen in this figure, special stick 40 (of about 20 cm long) and clips 50 that attach the rootstock to the stick have been used to support the young grafted plug plant. Furthermore, methods and means such as cut flowers, trailing net and a plastic tray frame may be used in order to support the grown grafted plant.

Reference is now made to FIG. 5 presenting a photographic illustration of a plurality of high stem grafted ornamental pepper plants planted in pots as compared to a corresponding

ungrafted ornamental pepper (500). This embodiment demonstrates the novel and inventive grafted herbaceous plant designs and method for producing them.

Reference is now made to FIG. 6 presenting a photographic illustration of different growth phases of Ocimum kilimandscharicum×O. basilicum F1 ‘Magic Mountain’™ rootstock (A-C) and a high stem grafted plug plant comprising the Ocimum kilimandscharicum×O. basilicum F1 ‘Magic Mountain’™ rootstock engrafted with Ocimum basilicum var. minimum ‘el Greco’ variety (D). In this embodiment, a unique and novel high stem grafted herbaceous propagation material is produced. A rootstock cutting derived from an Ocimum kilimandscharicum×O. basilicum F1 ‘Magic Mountain’™ plant (A) is planted into plug trays for growth and development of roots for about 10 days (B). The rootstock plant is grown to a predetermined height of about 20 cm after a period of about 30 days (C) and is ready to be grafted with the selected scion. A high stem grafted plug plant of the Labiatae family is produced after about 45 days, comprising an Ocimum basilicum var. minimum ‘el Greco’ variety (‘Greek’ Basil) scion or crown grafted upon an Ocimum kilimandscharicum×O. basilicum F1 ‘Magic Mountain’™ type rootstock at a height of about 20 cm. As can be seen in this figure, special stick 40 (of about 20 cm long) and clips 50 that attach the rootstock to the stick have been used to support the young grafted plug plant. Furthermore, methods and means such as cut flowers, trailing net and a plastic tray frame may be used in order to support the grown grafted plant.

It is within the scope of the present invention that Ocimum species, cultivars, hybrids or varieties used for the production of the high stem grafted plants encompass entries of Ocimum accessions described in Table 1 of Yariv Ben Naim et al (2015) Resistance Against Basil Downy Mildew in Ocimum Species, Genetics and Resistance Vol. 105, incorporated herein by reference.

This high stem grafted plug plant or propagation material provides a new combination and morphological design which may have desirable added value such as sturdiness, strong root system, heat, alkalinity and/or salt tolerance, tolerance to pathogens as compared to the currently available weak and sensitive herbaceous plant varieties.

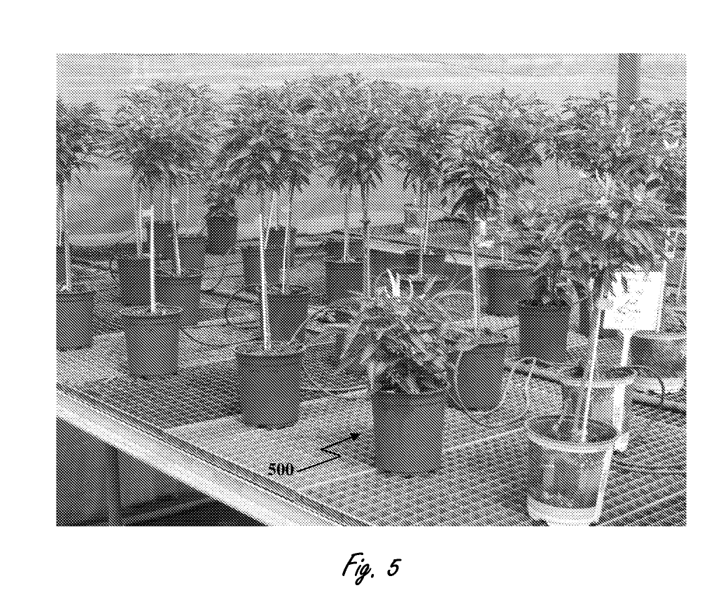

Reference is now made to FIG. 7 presenting a photographic illustration of a mature high stem grafted plant of the Labiatae or Lamiaceae family planted in a pot. In this embodiment, an Ocimum basilicum scion (e.g. Ocimum basilicum var, minimum or Greek Basil) is grafted upon a rootstock of the Ocimum kilimandscharicum×O. basilicum F1 ‘Magic Mountain’™ species. It is herein emphasised that a grafted herb plant, such as the Ocimum species are provided in a new commercially desirable morphological design, on a high stock or trunk of at least 7 cm height.

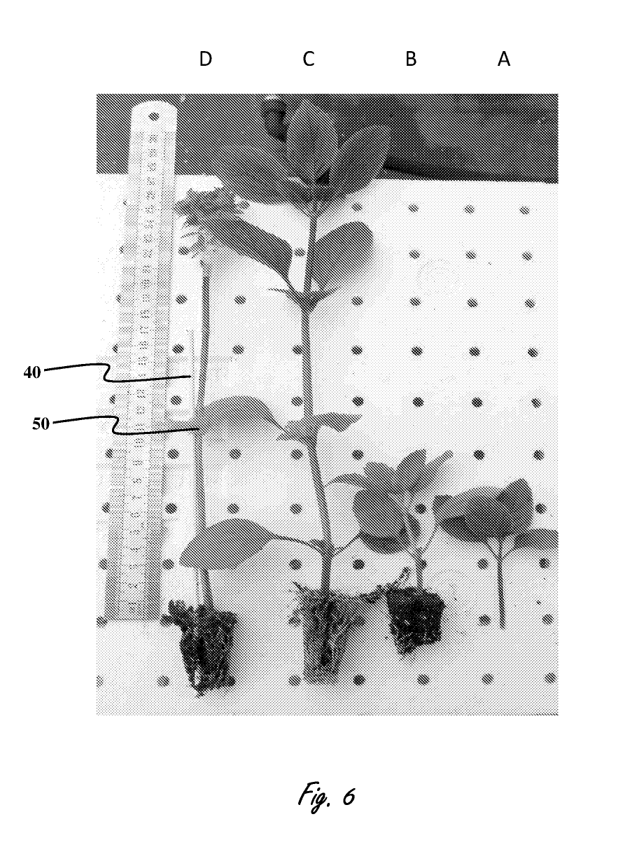

Reference is now made to FIG. 8 presenting a photographic illustration of a high stem grafted Calibrachoa plant grown for at least two months under greenhouse conditions. In this embodiment, a Calibrachoa scion of the Solanaceae family is engrafted upon a petunia rootstock of the Solanaceae family at a height of about 16 cm.

It is herein emphasized that the grafting of a scion, particularly herbaceous scion, onto a compatible rootstock at a height of at least 7 cm can be done by any conventional grafting technique known in the art and more specifically by a grafting technique suitable for grafting herbaceous plants. Non-limiting examples of grafting methods used in the present invention may include splice grafting, bud grafting, cleft grafting, clip grafting, side grafting, approach grafting, hole insertion grafting, one cotyledon grafting, whip grafting, stub grafting, four flap grafting, awl grafting, veneer grafting and any other grafting technique suitable for grafting herbaceous plant and any combination thereof.

The present invention provides a high stem grafted herbaceous plant, wherein the grafted plant comprises herbaceous scion engrafted upon a rootstock at a predetermined height of at least 7 cm.

It is further within the scope of the present invention that the scion as defined above is engrafted upon the rootstock at a predetermined height of between about 7 cm and about 50 cm.

It is according to a further embodiment of the present invention, wherein the scion is engrafted upon the rootstock at a predetermined height of between about 10 cm and about 50 cm.

It is further within the scope of the present invention that the scion as defined above is of length of between about 7 cm and about 30 cm.

It is further within the scope of the present invention that the scion as defined above is compatible with the rootstock.

It is further within the scope of the present invention to provide the high stem grafted plant as defined in any of the above, wherein the rootstock is herbaceous plant.

It is according to a further embodiment of the present invention, wherein the scion and/or the rootstock is derived from a hybrid plant.

It is according to a further embodiment of the present invention, wherein the scion and/or the rootstock belongs to a family selected from the group consisting of: Solanaceae, Lamiaceae (or Labiatae), Lobeliaceae, Asteraceae, Scrophulariaceae, Caryophyllaceae, Cucurbitaceae, and any combination thereof.

It is according to a further embodiment of the present invention, wherein the scion and/or the rootstock is a genus selected from the group consisting of Solanum, Capsicum, Petunia, Calibrachoa, Physalis and Ocimum and any combination thereof.

It is further within the scope of the present invention to provide the high stem grafted plant as defined in any of the above, wherein the scion and/or the rootstock is a species selected from the group consisting of: Solanum melongena, S. betaceum (Tamarillo) and Physalis philadelphica (Tomatillo) and any combination thereof.

It is further within the scope of the present invention to provide the high stem grafted plant as defined in any of the above, wherein the scion is selected from the group consisting of: ‘Lobelia’, ‘Lobelia erinus’, Gerbera, Gazania, Bidens, Bidens ferulifolia, Bacopa, Bacopa monnieri, Dianthus, Dianthus chinensis, Angelonia, Lycopersicon lycopersicum, Lycopersicon lycopersicum cherry tomatoes, Thymus, Lavandula, Origanum, Salvia, Artemisia, Artemisia abrotanum and Majorana syriaca zaatar and any combination thereof.

It is further within the scope of the present invention to provide the high stem grafted plant as defined in any of the above, wherein the scion is selected from the group of Capsicum species consisting of: C. annuum, C. baccatuum, C. chinense, C. frutescents and C. pubescen and any combination thereof.

It is further within the scope of the present invention to provide the high stem grafted plant as defined in any of the above, wherein the scion is an ornamental pepper variety or cultivar.

It is further within the scope of the present invention to provide the high stem grafted plant as defined in any of the above, wherein the scion is an ornamental pepper variety or cultivar of a Capsicum annuum species.

It is further within the scope of the present invention to provide the high stem grafted plant as defined in any of the above, wherein the scion is of the Ocimum species.

It is further within the scope of the present invention to provide the high stem grafted plant as defined in any of the above, wherein the scion is selected from the group of Ocimum species, cultivars or varieties consisting of: Ocimum×africanum, Ocimum americanum, Ocimum amicorum, Ocimum angustifolium, Ocimum basilicum, Ocimum burchellianum, Ocimum campechianum, Ocimum canescens, Ocimum carnosum, Ocimum centraliafricanum, Ocimum circinatum, Ocimum coddii, Ocimum cufodontii, Ocimum dambicola, Ocimum decumbens, Ocimum dhofarense, Ocimum dolomiticola, Ocimum ellenbeckii, Ocimum empetroides, Ocimum ericoides, Ocimum filamentosum, Ocimum fimbriatum, Ocimum fischeri, Ocimum formosum, Ocimum forskoelei, Ocimum fruticosum, Ocimum grandiflorum, Ocimum gratissimum, Ocimum hirsutissimum, Ocimum irvinei, Ocimum jamesii, Ocimum kenyense, Ocimum kilimandscharicum, Ocimum labiatum, Ocimum lamiifolium, Ocimum masaiense, Ocimum mearnsii, Ocimum metallorum, Ocimum minimum, Ocimum minutiflorum, Ocimum mitwabense, Ocimum monocotyloides, Ocimum motjaneanum, Ocimum natalense, Ocimum nudicaule, Ocimum nummularia, Ocimum obovatum, Ocimum ovatum, Ocimum pseudoserratum, Ocimum pyramidatum, Ocimum reclinatum, Ocimum serpyllifolium, Ocimum serratum, Ocimum somaliense, Ocimum spectabile, Ocimum spicatum, Ocimum tenuiflorum, Ocimum transamazonicum, Ocimum tubiforme, Ocimum urundense, Ocimum vandenbrandei, Ocimum vanderystii, Ocimum viphyense, Ocimum waterbergense, Ocimum×citriodorum (O. americanum×O. basilicum), Lemon basil, Ocimum kilimandscharicum×basilicum ‘Dark Opal’, African blue basil, basilicum, kilimandscharicum, minimum, herbalea, ‘Globe’ basil, ‘dwarf’ basil, ‘French’ basil, Ocimum basilicum var. minimum ‘Greek’ Basil, entries of Ocimum accessions described in Table 1 of Yariv Ben Naim et al (2015) Resistance Against Basil Downy Mildew in Ocimum Species, Genetics and Resistance Vol. 105 and any combination thereof.

It is further within the scope of the present invention to provide the high stem grafted plant as defined in any of the above, wherein the scion is selected from the group of Calibrachoa species consisting of: Calibrachoa caesia, Calibrachoa calycina, Calibrachoa dusenii, Calibrachoa eglandulata, Calibrachoa elegans, Calibrachoa ericaefolia, Calibrachoa excellens, Calibrachoa hassleriana, Calibrachoa heterophylla, Calibrachoa humilis, Calibrachoa linearis, Calibrachoa parviflora, Calibrachoa pygmaea, Calibrachoa rupestris, Calibrachoa sellowiana, Calibrachoa spathulata and Calibrachoa thymifolia.

It is further within the scope of the present invention to provide the high stem grafted plant as defined in any of the above, wherein the rootstock belongs to a family selected from the group consisting of Solanaceae and Lamiaceae or Labiatae.

It is further within the scope of the present invention to provide the high stem grafted plant as defined in any of the above, wherein the rootstock is selected from the group consisting of Cestroideae, Goetzeoideae, Nicotianoideae, Petunioideae, Schizanthoideae, Schwenckioideae and Solanoideae subfamily.

It is further within the scope of the present invention to provide the high stem grafted plant as defined in any of the above, wherein the rootstock and/or the scion is selected from the group of Capsicum species consisting of: Capsicum annuum, Capsicum annuum L., Capsicum baccatum L., Capsicum buforum Hunz., Capsicum campylopodium Sendtn., Capsicum cardenasii Heiser & P. G. Sm., Capsicum ceratocalyx M. Nee, Capsicum chacoense Hunz., Capsicum chinense Jacq., Capsicum coccineum (Rusby) Hunz., Capsicum cornutum (Hiern) Hunz., Capsicum dimorphum (Miers) Kuntze, Capsicum dusenii Bitter, Capsicum eximium Hunz., Capsicum flexuosum Sendtn., Capsicum friburgense Bianch. & Barboza, Capsicum frutescens L., Capsicum galapagoense Hunz., Capsicum geminifolium (Dammer) Hunz., Capsicum havanense Kunth, Capsicum hookerianum (Miers) Kuntze, Capsicum hunzikerianum Barboza & Bianch., Capsicum lanceolatum (Greenm.) C. V. Morton & Standl., Capsicum leptopodum (Dunal) Kuntze, Capsicum lycianthoides Bitter, Capsicum minutiflorum (Rusby) Hunz., Capsicum mirabile Mart. ex Sendtn., Capsicum mositicum Toledo, Capsicum parvifolium Sendtn., Capsicum pereirae Barboza & Bianch., Capsicum pubescens Ruiz & Pay., Capsicum ramosissimum Witasek, Capsicum recurvatum Witasek, Capsicum rhomboideum (Dunal) Kuntze, Capsicum schottianum Sendtn., Capsicum scolnikianum Hunz., Capsicum spina-alba (Dunal) Kuntze, Capsicum stramoniifolium (Kunth) Standl., Capsicum tovarii Eshbaugh et al., Capsicum villosum Sendtn.

It is further within the scope of the present invention to provide the high stem grafted plant as defined in any of the above, wherein the rootstock is selected from the group of Petunia species consisting of: Petunia alpicola, P. altiplana, P. axillaris, P. bajeensis, P. bonjardinensis, P. exserta, P. guarapuavensis, P. helianthemoides, P. humifusa, P. inflate, P. integrifolia, P. interior, P. ledifolia, P. littoralis, P. mantiqueirensis, P. occidentalis, P. parviflora, P. patagonica, P. pubescens, P. reitzii, P. riograndensis, P. saxicola, P. scheideana, P. variabilis, P. villadiana, P.×atkinsiana and P. hybrida.

It is further within the scope of the present invention to provide the high stem grafted plant as defined in any of the above, wherein the rootstock is selected from the group of species consisting of: Capsicum annuum, Ocimum basilicum, Solanum lycopersicum L., S. tuberosum and S. melongena.

It is further within the scope of the present invention to provide the high stem grafted plant as defined in any of the above, wherein the grafted plant comprises engrafted pairs of compatible rootstock and scion selected from the group consisting of a rootstock of the Petunia genus engrafted with a scion of the Calibrachoa genus, a rootstock of the Capsicum annuum species engrafted with a scion of the Ornamental pepper Capsicum annuum species, a rootstock of the Ocimum species engrafted with a scion of the Ocimum species, a rootstock of the solanum lycopersicum species engrafted with a scion of the S. lycopersicum species, a rootstock of the solanum melongena species engrafted with a scion of the S. lycopersicum species, a rootstock of the solanum melongena species engrafted with a scion of the S. melongena species, and a rootstock of the Origanum vulgare species engrafted with a scion of the O. vulgare species.

It is further within the scope of the present invention to provide the high stem grafted plant as defined in any of the above, wherein the grafted plant is derived from grafted high stem propagation material selected from the group consisting of grafted high stem young plants and grafted high stem unrooted raw material.

It is further within the scope of the present invention to provide the high stem grafted plant as defined in any of the above, wherein the young plants are selected from the group consisting of rooted cuttings, seedlings, grafted high stem rooted cuttings and grafted high stem seedlings.

It is further within the scope of the present invention to provide the high stem grafted plant as defined in any of the above, wherein the unrooted raw material is selected from the group consisting of unrooted cuttings and grafted high stem unrooted cuttings.

It is further within the scope of the present invention to provide the high stem grafted plant as defined in any of the above, wherein the unrooted raw material is adapted for insertion and growth in plug trays.

It is further within the scope of the present invention to provide the high stem grafted plant as defined in any of the above, wherein the grafted high stem unrooted raw material is adapted for perpendicular stability and/or sturdiness when planted in a plug tray.

It is further within the scope of the present invention to provide a high stem grafted finished plant derived from the propagation material as defined in any of the above.

It is further within the scope of the present invention to provide the high stem grafted finished plant as defined in any of the above, wherein the plant is adapted for perpendicular stability and/or sturdiness when planted in a pot or planting container.

It is further within the scope of the present invention to provide the high stem grafted finished plant as defined in any of the above, wherein the plant is adapted for planting as bedding plants.

It is further within the scope of the present invention to provide the high stem grafted plant as defined in any of the above, wherein the rootstock has at least one compatible characteristic with the scion.

It is further within the scope of the present invention to provide the high stem grafted plant as defined in any of the above, wherein the at least one compatible characteristic is selected from the group consisting of: stem diameter, growth pattern, taxonomical similarity, genetic similarity, anatomical similarity, growth rate, enhanced or reduced flowering, enhanced or reduced fruit size, enhanced or reduced fruit yield, internode number, internode diameter, internode and/or stem color, stem habit, root stock and/or scion woodification, and any combination thereof.

It is further within the scope of the present invention to provide the high stem grafted plant as defined in any of the above, wherein the rootstock and/or the scion has at least one desirable agronomical, horticultural and/or ornamental characteristic.

It is further within the scope of the present invention to provide the high stem grafted plant as defined in any of the above, wherein the at least one desirable agronomical, horticultural and/or ornamental characteristic of the rootstock is selected from the group consisting of strong root system, enhanced stem height or high stem, plant vigor, vigorous growth, sturdiness, stress tolerance, resistance or tolerance to biotic stress, resistance or tolerance to disease agents such as viruses, bacteria, fungi, resistance or tolerance to pests and weeds, disease resistance or tolerance, pest resistance or tolerance, resistance to pathogens, resistance to insect infestation, prevention of contaminants penetration to the scion, resistance to abiotic stress, resistance to nutrient deficiencies, improved seed yield, improved growth rate, desirable interaction between the rootstock and the scion, induced dwarfism, induced scion-crown density, enhanced vigor, induced sturdiness and/or thickness of the rootstock, enhanced germination, enhanced rooting potential, minimal sprout differentiation from callus, minimal side-shoots from the rootstock stem, enhanced rootstock stem thickness, maximal elongation of internodes, robustness, straight stem, thickness and any combination thereof.

It is further within the scope of the present invention to provide the high stem grafted plant as defined in any of the above, wherein the stress tolerance characteristic comprises an abiotic stress tolerance characteristic selected from the group consisting of cold tolerance, high temperature tolerance, drought tolerance, flood tolerance, salt tolerance, ionic phytotoxicity tolerance, pH tolerance and any combination thereof.

It is further within the scope of the present invention to provide the high stem grafted plant as defined in any of the above, wherein the stress tolerance characteristic comprises a biotic stress tolerance characteristic selected from the group consisting of a disease resistance, an insect resistance, tolerance to parasitic weeds, a nematode resistance, improved resistance to soil borne pests and any combination thereof.

It is further within the scope of the present invention to provide the high stem grafted plant as defined in any of the above, wherein the desirable agronomical and/or horticultural characteristic is selected from the group consisting of a rooting potential of at least 80%, sprout differentiation from callus lower than 80%, side shoots from the stem lower than 90%, average stem thickness of at least 5 mm, average internode length of at least 10 mm and any combination thereof.

It is further within the scope of the present invention to provide the high stem grafted plant as defined in any of the above, wherein the rootstock is engrafted with at least two different scions the scions belong to different varieties and are compatible with the rootstock.

It is further within the scope of the present invention to provide the high stem grafted plant as defined in any of the above, wherein the different scions have at least one different characteristic selected from the group consisting of: inflorescence color, fruit shape, growth pattern and any combination thereof.

It is further within the scope of the present invention to provide the high stem grafted plant as defined in any of the above, wherein the scion is characterized by at least one characteristic selected from the group consisting of dense flowering, unique flower color, low to moderate incompatibility with the rootstock, at least 50% output of developed plants, desirable aroma, enhanced fruit yield, dense foliage, upright fruits, small conic fruits, many fruits in cluster, different colors, short nodes, compact crown, many branches, unripe fruits, large fruits, un-clustered fruits, short to medium internodes, vigorousness, large and tall crown, compactness, branched, colourful fruits, sweet taste, non-pungent fruits, non-toxic, long internodes, high yield, multiple taste, multiple flower colors, dwarf and compact, tolerance to root and foliage diseases, crown shape, standard commercial yield, stress tolerance, dense flowering, unique colors, natural ball-shaped crown, creeping stems, and any combination thereof.

It is further within the scope of the present invention to provide the high stem grafted plant as defined in any of the above, wherein the high stem grafted plant has at least one desirable ornamental, horticultural and/or agronomical characteristic relative to a corresponding non-grafted scion plant, the at least one characteristic is selected from the group consisting of: desirable ornamental or esthetic design, enhanced height or high stem plant, avoidance of new root development or secondary root development from the upper parts of the plant, limitation of pruning wounds, sturdiness, strong root system, tolerance to biotic stress, tolerance to abiotic stress, tolerance to soil borne pests and diseases, tolerance to parasitic weeds, prevention of contaminants penetration to the scion, uniformity, reduced leaf yellowing, robust growth, plant vigor, vigorous growth, enhanced inflorescence yield, enhanced fruit yield, enhanced fruit size, enhanced fruit number, enhanced yield of plant propagation material such as cuttings, enhanced aerial yield, combination of more than one species or variety on one plant, normal development similar to a corresponding non-grafted control plant, and any combination thereof.

It is further within the scope of the present invention to provide the high stem grafted plant as defined in any of the above, wherein the high stem grafted plant is planted into a final commercial planter or pot or any other growing container, or bedding.

It is further within the scope of the present invention to provide the high stem grafted plant as defined in any of the above, wherein the high stem rootstock is compatible with grafting machines or other automatic and/or mechanic agro techniques.

It is further within the scope of the present invention to provide the high stem grafted plant as defined in any of the above, wherein the final commercial planter or pot or any other growing container has a volume of 1 liter and less.

It is further within the scope of the present invention to provide the high stem grafted plant as defined in any of the above, wherein the final commercial planter or pot or any other growing container has a volume of 1 liter and more.

It is further within the scope of the present invention to provide the high stem grafted plant as defined in any of the above, wherein the final commercial planter or pot or any other growing container has a volume of between about 0.1 liter and about 2 liter.

It is further within the scope of the present invention to provide the cuttings or unrooted cuttings, grafted cuttings or grafted unrooted cuttings derived from the high stem grafted herbaceous plant as defined in any of the above.

It is further within the scope of the present invention to provide any plant part of the high stem grafted herbaceous plant as defined in any of the above.

It is further within the scope of the present invention to provide the plant part as defined in any of the above, wherein the plant part is selected from the group consisting of rooted cuttings, unrooted cuttings, grafted rooted cuttings, unrooted grafted cuttings, plant cell, tissue culture, meristem, flowers and any other vegetative or reproductive part of the plant.

It is further within the scope of the present invention to provide high stem grafted propagation material, wherein the high stem grafted propagation material comprises a scion engrafted upon a rootstock at a predetermined height of at least 7 cm, further wherein the high stem propagation material is selected from the group consisting of grafted high stem young plants, grafted high stem rooted cuttings, grafted high stem unrooted cuttings and grafted high stem seedlings.

It is further within the scope of the present invention to provide a method for producing a high stem grafted herbaceous plant comprising steps of: (a) providing a herbaceous scion plant; (b) selecting a rootstock which is compatible with the scion plant; (c) growing the rootstock under predetermined agrotechnical conditions so as to produce a rootstock with a predetermined stem height of at least 7 cm and growth characteristics suitable for grafting with the scion; (d) growing the herbaceous scion plant under agrotechnical conditions, so as to provide a scion with growth characteristics suitable for grafting with the rootstock; and (e) grafting the scion onto the rootstock at the predetermined stem height of at least 7 cm, thereby producing a high stem grafted herbaceous plant.

It is further within the scope of the present invention to provide the method as defined above, further comprising steps of growing the rootstock to a predetermined height of about 10 cm and up to 50 cm.

It is further within the scope of the present invention to provide the method as defined in any of the above, comprising additional steps of adjusting the density of the grown rootstock plants by controlling the number of plants per area.

It is further within the scope of the present invention to provide the method as defined in any of the above, comprising additional steps of selecting a growth tray suitable for growing the rootstock by parameters selected from the group consisting of size, shape of cells, material, density and any combination thereof.

It is further within the scope of the present invention to provide the method as defined in any of the above, comprising additional steps of selecting the agrotechnical conditions from the group consisting of: growth media, fertilizing solution and regime, irrigation regime, temperature, relative humidity, electrical conductivity, illuminating level, shading level, illumination or radiation regime, pH and any combination thereof.

It is further within the scope of the present invention to provide the method as defined in any of the above, comprising additional steps of selecting the growth characteristics from the group consisting of: stem diameter, stem height, flowering time, hypocotyl size, hypocotyl length, nodes number, node length, internode number, internode diameter, internode and/or stem color, stem habit, root stock and/or scion woodification, growth pattern and any combination thereof.

It is further within the scope of the present invention to provide the method as defined in any of the above, comprising additional steps of controlling at least one parameter of the grown rootstock, the at least one parameter is selected from the group consisting of hypocotyl size, hypocotyl length, stem diameter, nodes number, internode length, woodification, and any combination thereof.

It is further within the scope of the present invention to provide the method as defined in any of the above, comprising additional steps of growing the rootstock plant for a period of between about 30 days to about 45 days from planting until grafting, depending on the growth season.

It is further within the scope of the present invention to provide the method as defined in any of the above, comprising additional steps of growing the scion for about 25 days to about 35 days from planting until grafting, depending on the growth season.

It is further within the scope of the present invention to provide the method as defined in any of the above, comprising additional steps of regulating the growth of the rootstock and/or scion.

It is further within the scope of the present invention to provide the method as defined in any of the above, comprising additional steps of regulating the growth by means selected from the group consisting of applying controlled Low-Radiation regimes for obtaining etiolated rootstock plants, applying predetermined wave length regimes, applying plant growth regulators (PGRs) such as plant hormones, phytohormones and chemicals.

It is further within the scope of the present invention to provide the method as defined in any of the above, comprising additional steps of controlling the flowering timing of the grown rootstock plants by affecting photoperiodic response of the plants.

It is further within the scope of the present invention to provide the method as defined in any of the above, further comprising steps of grafting the scion onto the rootstock by a grafting technique selected from the group consisting of: splice grafting, bud grafting, cleft grafting, side grafting, approach grafting, tongue approach grafting, tube-grafting, hole insertion grafting, one cotyledon grafting, whip grafting, stub grafting, four flap grafting, awl grafting, veneer grafting and by any other grafting technique suitable for grafting herbaceous plant and any combination thereof.

It is further within the scope of the present invention to provide the method as defined in any of the above, comprising additional steps of using trailing and stabilizing means for supporting and shaping the grown rootstock or the grafted high stem plant.

It is further within the scope of the present invention to provide the method as defined in any of the above, comprising additional steps of selecting the trailing and stabilizing means from the group consisting of sticks, clips, flowers cutting, trailing net, plastic tray frame and any combination thereof.

It is further within the scope of the present invention to provide the method as defined in any of the above, comprising additional steps of applying plant protection treatments selected from the group consisting of: pesticide-based treatment, herbicides treatment, insecticides treatment, fungicides treatment, biological pest control treatment, physical treatment such as heat, cold, light, high-pressure or vacuum, spraying with gas or liquids, immersion in liquids or oils and any combination thereof.

It is further within the scope of the present invention to provide the method as defined in any of the above, further comprising steps of enhancing adhesion and healing processes between the scion and the rootstock to form a graft union.

It is further within the scope of the present invention to provide the method as defined in any of the above, wherein the step of enhancing adhesion and healing between the scion and the rootstock to form a graft union is performed for a period of about 14 days to about 21 days after the grafting step.

It is further within the scope of the present invention to provide the method as defined in any of the above, further comprising steps of planting the grafted plant into a final commercial planter or pot or any other growing container or bedding.

It is further within the scope of the present invention to provide the method as defined in any of the above, further comprising steps of planting the grafted plant into a final commercial planter or pot or any other growing container having a volume of 1 liter and less.

It is further within the scope of the present invention to provide the method as defined in any of the above, further comprising steps of planting the grafted plant into a final commercial planter or pot or any other growing container having a volume of 1 liter and more.

It is further within the scope of the present invention to provide the method as defined in any of the above, further comprising steps of planting the grafted plant into a final commercial planter or pot or any other growing container having a volume of between about 0.1 liter and about 2 liter.

It is further within the scope of the present invention to provide the method as defined in any of the above, further comprising steps of growing the grafted plant in the final commercial planter or pot or any other growing container for about 60 days to about 90 days to achieve a high stem grafted plant suitable for marketing to a late stage in the supply chain such as end user or florists.

It is further within the scope of the present invention to provide the method as defined in any of the above, further comprising steps of producing a high stem grafted herbaceous plant with desirable ornamental and/or horticultural characteristics relative to a corresponding non-grafted scion plant selected from the group consisting of: desirable ornamental or esthetic design, enhanced height or high stem plant, avoidance of new root development or secondary root development from the upper parts of the plant, limitation of pruning wounds, strong root system, tolerance to biotic stress, tolerance to abiotic stress, tolerance to parasitic weeds, uniformity, reduced leaf yellowing, robust growth, enhanced inflorescence yield, enhanced yield of plant propagation material such as cuttings, enhanced aerial yield, new ornamental design, combination of more than one species or variety on one rootstock plant and any combination thereof.

It is further within the scope of the present invention to provide any part of a high stem grafted herbaceous plant produced by the method as defined in any of the above.

It is further within the scope of the present invention to provide the plant part as defined above, wherein the plant part is selected from the group consisting of rooted cuttings, unrooted cuttings, grafted rooted cuttings, unrooted grafted cuttings, plant cell, tissue culture, meristem, flowers and any other vegetative or reproductive part of the plant.

It is further within the scope of the present invention to provide high stem grafted propagation material produced by the method as defined in any of the above, wherein the propagation material is selected from the group consisting of high stem grafted young plants, high stem grafted rooted cuttings, high stem grafted unrooted cuttings and high stem grafted seedlings.

It is further within the scope of the present invention to provide the method as defined in any of the above, further comprising steps of selecting herbaceous rootstock compatible with the herbaceous scion.

It is further within the scope of the present invention to provide the method as defined in any of the above, further comprising steps of engrafting the rootstock with at least two different scions, the scions belong to different varieties and are compatible with the rootstock.

It is further within the scope of the present invention to provide the method as defined in any of the above, further comprising steps of providing the different scions having at least one different characteristic selected from the group consisting of: inflorescence color, fruit shape, growth pattern and any combination thereof.

It is further within the scope of the present invention to provide the method as defined in any of the above, comprising additional steps of producing and growing high stem grafted propagation material selected from the group consisting of high stem grafted young plants and high stem grafted unrooted raw material at predetermined growth conditions so as to provide the high stem grafted plant.

It is further within the scope of the present invention to provide the method as defined in any of the above, further comprising steps of selecting the young plants from the group consisting of rooted cuttings, seedlings, high stem grafted rooted cuttings, and grafted seedlings.

It is further within the scope of the present invention to provide the method as defined in any of the above, further comprising steps of selecting the unrooted raw material from the group consisting of unrooted cuttings and high stem grafted unrooted cuttings.

It is further within the scope of the present invention to provide the method as defined in any of the above, further comprising steps of growing the unrooted raw material in plug trays.

It is further within the scope of the present invention to provide the method as defined in any of the above, further comprising steps of growing the propagation material so as to produce a finished grafted high stem plant.

It is further within the scope of the present invention to provide a method of producing a herbaceous grafted scion free of soil borne disease comprising the steps of: (a) providing a herbaceous scion plant; (b) selecting a rootstock which is compatible with the scion; (c) growing the rootstock under predetermined agrotechnical conditions so as to produce a rootstock with a predetermined stem height of at least 7 cm and growth characteristics suitable for grafting with the scion; (d) growing the scion plant under agrotechnical conditions, so as to provide a scion with growth characteristics suitable for grafting with the rootstock; and (e) grafting the scion onto the rootstock at the predetermined stem height of at least 7 cm; thereby producing a high stem grafted herbaceous scion free of soil borne diseases.

In order to understand the invention and to see how it may be implemented in practice, a plurality of preferred embodiments will now be described, by way of non-limiting example only, with reference to the following examples.

### Example 1

### Protocol for Producing a High Stem Grafted Plant

One example of a method for producing a high stem grafted herbaceous plant according to the present invention may encompass the following steps:

Step 1:

Selecting a scion and a compatible rootstock plant, suitable to be grafted. In specific embodiments, herbaceous plant is selected to be used as a scion and/or rootstock.

Step 2:

Growing the selected rootstock for a period of about 30 to about 60 days, particularly for about 30 to about 45 days (dependent on the season) under predetermined agrotechnical conditions to achieve a young herbaceous plant with a predetermined stem diameter and a predetermined stem height of between about 7 cm and about 50 cm, suitable for grafting with the selected compatible scion. Examples of such agrotechnical conditions may include illumination regime, shading, temperature, irrigation and fertilization regimes, humidity, soil parameters such as conductivity and soil suitability for bedding or preparing for bedding. The agrotechnical conditions are configured to produce a sturdy perpendicularly grown rootstock with predetermined stem parameters needed for successful grafting of an enhanced height herbaceous plant, such as stem height until the first node, stem diameter, length between nodes etc.

It is emphasized that up until now, the common grafting height, especially for herbaceous plants, was about 2 to about 5 cm above the ground. Thus unique agrotechnical parameters or conditions are used to achieve high stem grafted herbaceous plant. Furthermore, the grafting technique was not used up until now to produce high stem herbaceous plants.

It should be noted that the propagation material used for producing the rootstock may be selected from seeds, seedlings or cuttings. More specifically, the rootstock may be produced from young plants, rooted cuttings, unrooted cuttings, seedlings, grafted rooted cuttings, grafted unrooted cuttings or grafted unrooted seedlings. In the case of seeds the protocol is based on growing seedlings and using cuttings derived from the seedlings which are subjected to specific predetermined growth conditions adjusted to elongate the rootstock to the needed dimensions. The growth protocol for seeds as compared to cuttings is based on different lead time for each stage.

In a specific embodiment, rootstock plant cuttings are rooted in a planting tray under growth conditions optimal for producing erectly or upright sturdy herbaceous stem with a predetermined height of at least 7 cm above the ground suitable for grafting with the selected scion.

Particularly, the steps for growing the selected rootstock may encompass the following:

A. Adjusting the density of the grown rootstock plants (i.e. number of plants per area);

B. Selecting a suitable growth tray. The parameters for selecting such a suitable tray may include, in a non-limiting manner, size, shape of cells, material and density of the cells;

C. Applying controlled “Low-Radiation” regimes to produce elongated rootstock to the needed dimensions, such as stem height and stem diameter (i.e. for obtaining etiolated plants);

D. Controlling flowering timing, i.e. by affecting photoperiodic response of the plants;

E. Using trailing and stabilizing means to support the grown rootstock plants. Non-limiting examples of such means include sticks and clips and other means and methods such as cut flowers, using a trailing net and/or using a plastic tray frame in order to support the grown rootstock.

F. Growing the selected rootstock at predetermined protocol, i.e. by controlling parameters such as illumination level, temperature, relative humidity, electrical conductivity, pH, irrigation intervals and fertilization solutions and regimes;

G. Optionally, applying plant protection treatments (e.g. pesticide-based approaches such as herbicides, insecticides and fungicides and biological pest control approaches, physical treatment such as heat, cold, light, high-pressure or vacuum, spraying with gas or liquids, immersion in liquids or oils, and any combination thereof);

I. Coordinating, regulating and manipulating properties of the plant propagation material to be used for rootstock production, including properties such as: hypocotyl size, i.e. length; stem diameter and nodes number and length, internode number, internode diameter, internode and/or stem color, stem habit (upright or creeping), root stock and/or scion woodification, and any combination thereof.

Step 3:

Growing a selected herbaceous scion species suitable for grafting onto the selected rootstock, i.e. compatible with the rootstock. The scion may be derived from young plants or propagation material or raw material comprising rooted cuttings, unrooted cuttings, seedlings, grafted rooted cuttings, grafted unrooted cuttings or grafted unrooted seedlings. In a specific embodiment, scion cuttings are grown under conditions adapted to adjust the scion stem diameter to be suitable for the rootstock diameter and grafting technique. The growth of the scion is manipulated such that the scion is suitable for grafting with the selected rootstock by growth characteristics such as growth staging and timing and stem diameter. In certain embodiments, the scion is grown for about 25 days to about 35 days until grafting upon the rootstock.

Step 4:

Grafting the scion onto the manipulated rootstock at a predetermined height of at least 7 cm, by any suitable grafting technique or method. Optionally, using trailing and stabilizing means to support the grafted young or plug plant. Non-limiting examples of such trailing and stabilizing means include sticks, clips, flowers cutting, trailing net, plastic tray frame and any combination thereof.

Step 5:

Enhancing adhesion and hardening processes between the rootstock and scion tissues at the grafting area. It is herein acknowledged that during the healing process, the plant forms a callus or callus type tissue and reconnects vascular bundles within the stem. In specific embodiments, the adhesion stage period may take between about 14 days to about 21 days after the grafting act.

Step 6:

Planting the high stem grafted plug plant into a finalized or desired pot or growing container or planter and optionally using means to support the growth of the engrafted plug plant if required. The estimated period of time between planting of the high stem grafted young plant in a plug tray until the achievement of a finished high stem grafted herbaceous plant suitable for marketing, i.e. producing flowers or fruits, is from about 60 days to about 90 days.

It is further within the scope that the grafting protocol of the present invention is used to produce high stem grafted herbaceous propagation material in the form of young plants (such as grafted rooted cuttings and grafted seedlings) or any other raw material, such as unrooted grafted cuttings.

It is further within the scope that the grafting method may be any conventional or known grafting technique. In all methods employed, complementary ends of the scion and the rootstock are brought together to form a graft union. Callous tissue forms at the graft union as part of the normal healing process of the plant and serves as a conduit for water and nutrients between the scion and rootstock. Grafting involves the union of two independent plant parts into one plant. More specifically it may encompass any grafting technique which is suitable for grafting herbaceous plants, such as tomato plants. More particularly, the grafting method uses diagonal cutting with clips.

It is emphasized that the example described herein encompasses means and methods for grafting a scion of a flowering or vegetable or herbaceous plant, particularly herbaceous scion, with any selected rootstock, which is found to be compatible with the selected scion. Particularly, the example refers to means and methods for producing a high stem grafted herbaceous plant of the Solanaceae or Lamiaceae family. Furthermore, the example described herein encompasses means and methods for grafting a scion and/or a rootstock of a hybrid plant, variety or cultivar.

It is further emphasized that the exemplified method described herein encompasses the possibility of grafting two or more scions on one rootstock. In this embodiment, the two or more scions belong to different species within the same genus or different varieties of the same species. The different scions may have different characteristics such as inflorescence color, fruit shape and growing pattern. This enables the production of unique and surprising high stem grafted plants and grafted propagation material having ornamental and horticultural commercially desirable combinations.

### Example 2

### A Process for Producing Partially Commercial High-Stem Grafted Herbaceous Plant

1. Screening for Sources for Plant Propagation Material:
1.1. Identification of genetic sources for the rootstock and scion species selection, including different species of seeds and/or cuttings propagation material. After a preliminary screening of different genera of the families Solanaceae and Lamiaceae (or Labiatae), candidates were selected according to their horticultural traits and evaluation of their potential suitability for the desired enhanced height grafted plants.
   1.1.1. Propagation materials for high-stem grafted plants derived from the Solanaceae family:

TABLE 1
Propagation material for high-stem pepper (Capsicum annum)

| Commercial | | | | | |
|---|---|---|---|---|---|
| name | model | Use | Main qualities | uniformity | availability |
| Capsicun | Orange FTGG72; | Scion | Dense foliage, | High | Moderate |
| (Ornamental | Red FTGG73; | | upright fruits, small | | |
| Pepper) | Yellow FTGG74; | | conic fruits, many | | |
| Mambo ™ | Purple Red | | fruits in cluster; | | |
| | FTGG75 | | different colors, short | | |
| | | | nodes, compact | | |
| | | | crown, many | | |
| | | | branches; purple | | |
| | | | models enables | | |
| | | | unique purple | | |
| | | | flowering and unripe | | |
| | | | fruits | | |
| Capsicum | Multicolor Orange | Scion | Large upright fruits; | Moderate | Moderate |
| (Ornamental | FTGG96; | | Un-clustered fruits; | | |
| Pepper) | Multicolor Red | | different colors; | | |
| Cubana ™ | FTGG97; Red | | medium internodes; | | |
| | FTGG92; Yellow | | vigorous plant; | | |
| | FTGG93 | | Multicolor purple | | |
| | | | models enables early | | |
| | | | different colors of | | |
| | | | unripe fruits | | |
| Capsicum | Yellow; Red | Scion | Large and tall crown, | Low | High |
| (Ornamental | | | upright un-clustered | | |
| Pepper) | | | conic fruits; vigorous | | |
| Acapulco | | | plant | | |
| Capsicum | Red | Scion | Compact, dark green | Excellent | Moderate |
| annum F1 | | | foliage, upright | | |
| Ornamental | | | fruits; Bears conical | | |
| Pepper | | | white fruits changing | | |
| Treasures Red | | | to bright red at | | |
| | | | maturity | | |
| Medusa | | Scion | Naturally compact | Moderate | High |
| Ornamental | | | and well-branched, | | |
| Pepper | | | Produces colourful | | |
| | | | fruit - each with a | | |
| | | | narrow, twisted, cone | | |
| | | | shape - held | | |
| | | | prominently upright | | |
| | | | over the dark green | | |
| | | | foliage; Sweet taste | | |
| | | | (child-safe variety) | | |
| | | | bearing non-pungent | | |
| | | | fruit; easy-to-grow; | | |
| | | | A Hot Summer | | |
| | | | Survivors selection | | |
| Sweet bite | Red E49.9524; | Scion | Long internodes - | High | High |
| | Yellow E49.9526; | | enables high end- | | |
| | Orange E49.9531 | | product; medium bell | | |
| | | | fruits; high yield; | | |
| | | | different colors; taste | | |
| Maccabi | Capsicum annum | Rootstock | Robustness; straight; | Excellent | High |
| | rootstock | | thickness | | |

TABLE 2
Propagation material for high-stem tomato (Solanum lycopersicum)

| Commercial | | | | | |
|---|---|---|---|---|---|
| name | model | Use | Main qualities | uniformity | availability |
| Beaufort | Solanum | Rootstock | average vigor | High | High |
| | lycopersicum | | | | |
| | rootstock | | | | |
| Arnold | Solanum | Rootstock | Fast-growing; | Moderate | high |
| | lycopersicum | | generative plant habit | | |
| | rootstock | | | | |
| Ikram | Solanum | Scion | Yield, vigor, stress | Excellent | high |
| | lycopersicum | | tolerance | | |
| | cluster tomatoes | | | | |
| Resistar F1 | Solanum | Rootstock | Fast-growing; | Excellent | High |
| | lycopersicum | | generative plant habit | | |
| | rootstock | | | | |
| Classic F1 | Solanum | Rootstock | Compatibility with | Excellent | High |
| | melongena | | tomato scions | | |
| | Rootstock | | | | |
| Submarine | Solanum | Rootstock | Moderate vigor | high | high |
| 001 | lycopersicum | | | | |
| | rootstock | | | | |
| Tomate | Solanum | Scion | Dwarf and compact; | High | High |
| Ponchi ™-Re | lycopersicum | | taste; crown shape | | |
| F1 | Cocktail tomato, | | tolerance to root and | | |
| | red | | foliage diseases | | |
| Tomate | Solanum | Scion | Dwarf and compact; | High | High |
| Ponchi ™-Mi | lycopersicum | | taste; crown shape | | |
| F1 | | | | | |
| Dwarf tomato | Cherry tomato, red | Scion | Dwarf; Delivers full | Excellent | High |
| TT33 | | | sized cocktail | | |
| | | | tomatoes at standard | | |
| | | | commercial yield. | | |

TABLE 3
Propagation material for high-stem Calibrachoa

| | Commercial | | | Main desired | | |
|---|---|---|---|---|---|---|
| Variety | name | model | Use | qualities | uniformity | availability |
| Petunia surfinia | Surfinia | White; Burgundy; | Rootstock | Long internodes; | High | High |
| | | Hot pink; Purple; | | Robustness | | |
| | | Dark violet; | | | | |
| | | Yellow; Blue | | | | |
| | | spritz; Pink spritz | | | | |
| Petunia sp. | Happy Giant | Hot pink | Rootstock | Long internodes; | High | High |
| | | | | Robustness | | |
| Petunia sp. | Bingo | White; Blue; | Rootstock | Long internodes; | Low | High |
| | | Purple | | Robustness | | |
| Petunia sp. | Crazytunia | Mandeville; Stone- | Rootstock | Robustness | Low | Low |
| | | wash | | | | |
| Calibrachoa sp. | Chameleon | Lavender; Purple; | Scion | Dense flowering; | High | Low |
| | | Pink Passion | | Unique colors | | |
| Calibrachoa sp. | Celebration ® | White improved; | Scion | Dense flowering; | High | High |
| | | Yellow banana; | | Unique colors | | |
| | | Neon rose; | | | | |
| | | Mandarin; Cherry; | | | | |
| | | Violet | | | | |

1.1.2. Propagation materials for high-stem products derived from the Labiatae family.

TABLE 4
Propagation material for high-stem basil (Ocimum sp.)

| | Commercial | | | | | |
|---|---|---|---|---|---|---|
| Variety | name | model | Use | Main qualities | uniformity | availability |
| Ocimum | Basil ‘Magic | Green-purple | Rootstock | Long internodes; | High | High |
| kilimandscharicum × | Mountain’ ™ | | | Robustness; Cold | | |
| O. basilicum F1 | | | | tolerance; Disease | | |
| | | | | tolerance | | |
| Ocimum basilicum | Basil ‘el Greco’ | green | Scion | Natural ball-shaped | Low | Low |
| var. minimum | | | | crown; Small gentle | | |
| | | | | leaves, Aroma | | |
| Ocimum herbalea | Basil ‘Wild | Purple-green | Scion | Purple color | High | High |
| | Magic’ | | | | | |
| Ocimum herbalea | Basil ‘Lahsa’ | Purple-green | Scion | Moderately small | Moderate | High |
| | | | | leaves; Aroma | | |
| Ocimum herbalea | Basil ‘Dark | Dark purple | Scion | Gentle leaves, Dark | Low | High |
| | Lady’ | | | color | | |

TABLE 5
Propagation material for high-stem Origanum

| | Commercial | | | Main desired | | |
|---|---|---|---|---|---|---|
| Variety | name | model | Use | qualities | uniformity | availability |
| Origanum vulgare | Origanum | Green | Rootstock | Relativly long | Moderate | High |
| | vulgare | | | internodes; | | |
| | | | | Robustness; | | |
| Origanum vulgare | Origanum | Green | Scion | Aroma | Moderate | High |
| | vulgare | | | | | |
| Majorana syriaca | Za'atar | Green | Scion | Aroma | Moderate | High |
| Majorana syriaca | Za'atar | Green | Rootstock | Upright, Relativly | Moderate | High |
| | | | | long internodes; | | |
| | | | | Robustness; | | |
| Origanum vulgare | Origanum | Green-gold | Scion | Crown shape; | High | High |
| | ‘Aureum Gold’ | | | creeping stems; color | | |
| Origanum vulgare | Origanum | Green-white | Scion | creeping stems; color | Moderate | High |
| | ‘Aureum | | | | | |
| | Variegata’ | | | | | |
| Origanum vulgare | Origanum | Green | Scion | Round and soft | High | High |
| | ‘Compactum’ | | | leaves; Creeping | | |
| | | | | stems | | |

TABLE 6
Propagation material for high-stem Thymus

| | Commercial | | | Main desired | | |
|---|---|---|---|---|---|---|
| Variety | name | model | Use | qualities | uniformity | availability |
| Origanum vulgare | Origanum | Green | Rootstock | Relativly long | Moderate | High |
| | vulgare | | | internodes; | | |
| | | | | Robustness; | | |
| Thymus | Thymus ‘Tabor’ | Green | Scion | Crown shape; | High | High |
| pulegioides | | | | Aroma | | |

1.2. An additional screening of 70,000 breeding products has been performed. Candidates have been selected to be used as source material for rootstock and scion. Four rootstock candidates have been selected for further tests as described below (Table 7).

TABLE 7
Selected varieties of Petunia, to be tested as a rootstock

| | | | Rootstock candidate: Main desired qualities | | |
|---|---|---|---|---|---|
| Variety | Experimental name | model | Long Internodes | thickness | Sparse Flowering |
| Petunia sp. | 14-1914 | Pink | + | +++ | + |
| Petunia sp. | 14-1915 | Red star | ++ | ++ | ++ |
| Petunia sp. | 14-1916 | Purple-pink | +++ | + | +++ |
| Petunia sp. | 14-1917 | Purple | +++ | ++ | +++ |

2. Screening for Candidate Species to be Used as Scion and Rootstock.
2.1. Morphological identification of selected species according to properties such as germination, rooting potential, rooting quality, callus formation, sprouts from the callus and side-shoots development from the stem, presented in Tables 8-10.
   2.1.1. Morphological identification of Solanaceae; vegetable rootstocks produced from seeds, and processed for high-stem grafting use.
      Reference is now made to Table 8, presenting quality parameters of Capsicum and Solanum rootstocks. In this experiment, different Capsicum scions were grafted on Capsicum Maccabi rootstock and Solanum lycopersicum Dwarf tomato TT33 was grafted on different Solanum rootstocks. All the tests were conducted at least twice, 10 replicates per rootstock. The tested rootstock qualities included maximal germination and rooting potential; minimal sprout differentiation from callus and/or side-shoots from the stem; maximal stem thickness and elongation of internodes.

TABLE 8
Tested quality parameters of Capsicum and Solanum rootstocks.

| | | | | Average | Average |
|---|---|---|---|---|---|
| | | | Side-shoots | stem | elongation |
| | Commercial | Germination | from the | thickness | of internodes |
| Rootstock Var | name | potential (%) | stem (%) | (mm) | (mm) |
| Capsicum annum | Maccabi | 90 | 70 | 8 | 100 |
| Solanum | Beaufort | 90 | 90 | 5 | 80 |
| lycopersicum | | | | | |
| Solanum | Arnold | 90 | 90 | 6 | 70 |
| lycopersicum | | | | | |
| Solanum | Resistar F1 | 90 | 80 | 7 | 110 |
| lycopersicum | | | | | |
| Solanum | Submarine 001 | 90 | 80 | 5 | 110 |
| lycopersicum | | | | | |
| Solanum | Classic F1 | 90 | 30 | 5 | 60 |
| melongena | | | | | |

2.1.2. Morphological identification of Solanaceae; petunia rootstock produced from cuttings.

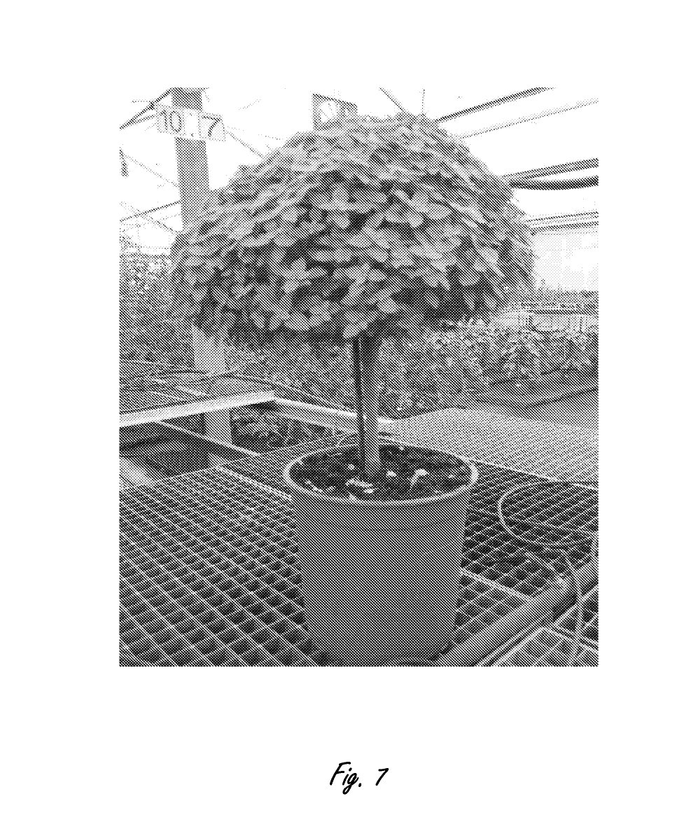

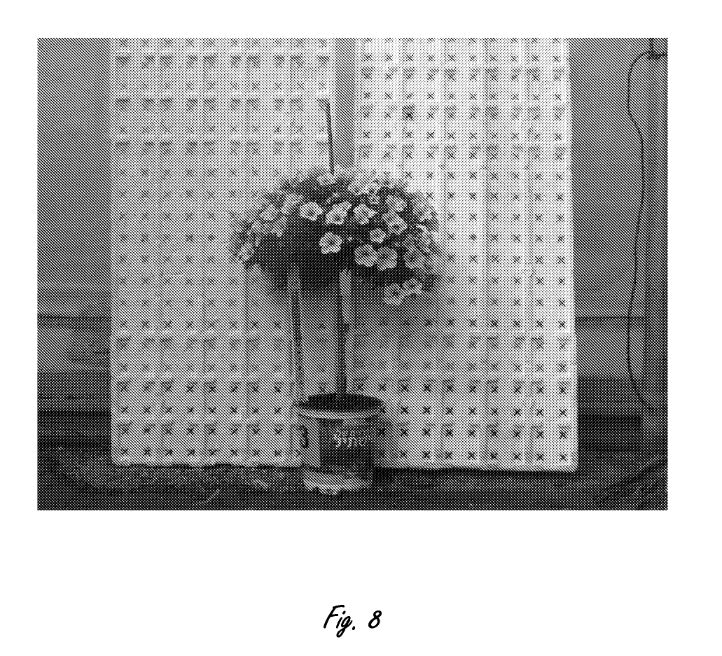

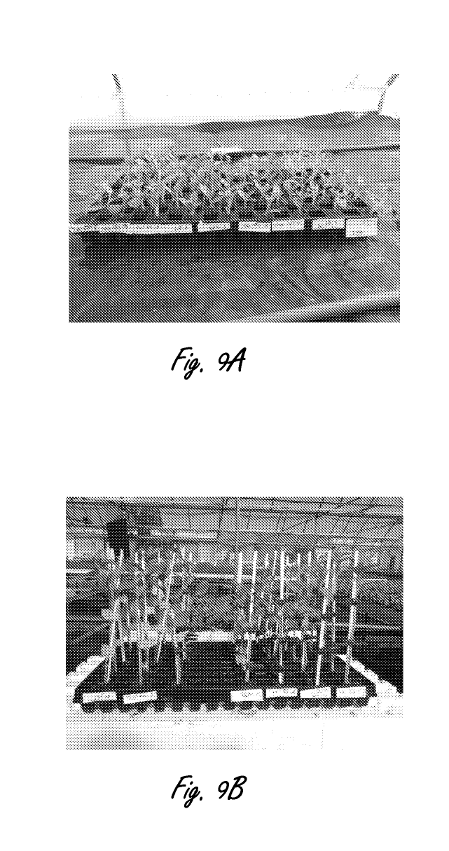

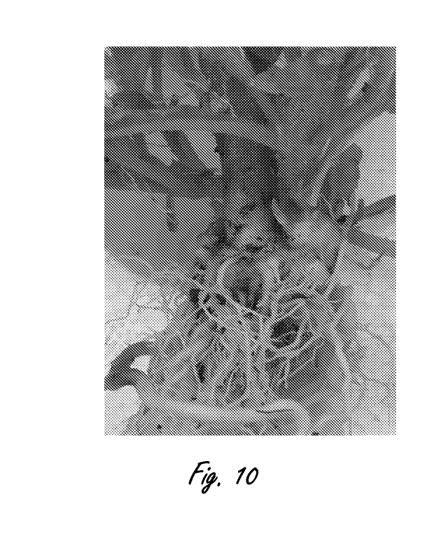

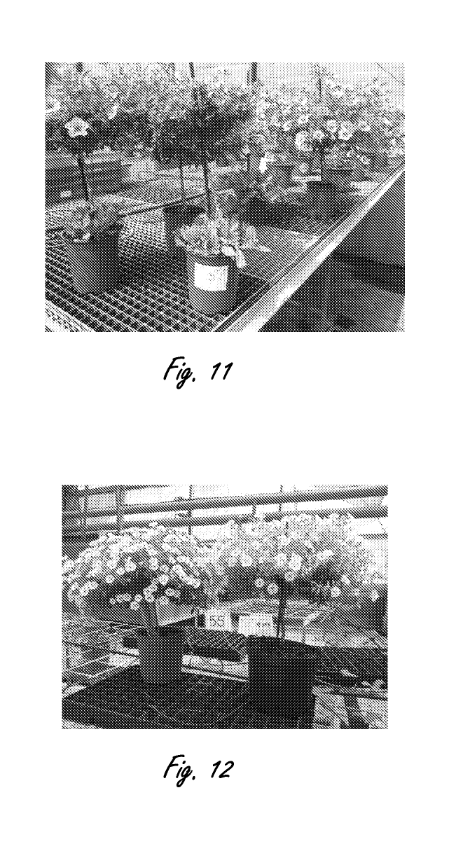

Reference is now made to Table 9, describing the effect of grafting Calibrachoa chameleon model Pink on different Petunia rootstocks, on rootstock quality parameters. The test was conducted twice, 10 replicates per rootstock. The desired properties included: maximal rooting potential (see FIG. 9); minimal sprout differentiation from callus (see FIG. 10) and/or side-shoots from the stem (see FIG. 11); maximal stem thickness and elongation of internodes (see FIG. 12).

Reference is now made to FIG. 9A presenting high rooting potential of petunia rootstocks according to some embodiments of the present invention.

Reference is now made to FIG. 9B presenting stretched petunia rootstock; the stretching has been achieved by applying adjusted protocols including fertigation and shading regimes during the rootstock growth.

Reference is now made to FIG. 10, photographically illustrating callus formation, rooting and the undesirable phenomena of sprouts growth from the callus of a Calibrachoa sp. grafted upon Petunia rootstocks.

Reference is now made to FIG. 11, photographically illustrating growth of sprouts from callus of a Calibrachoa sp. grafted upon Petunia rootstocks.

Reference is now made to FIG. 12, photographically illustrating different rootstock trunk development and thickness. On the left, a high stem grafted Calibrachoa plant with a relatively thick Petunia trunk or stem and on the right, a high stem grafted Calibrachoa plant with a relatively thin Petunia trunk.

TABLE 9
Effect of grafting Calibrachoa chameleon model Pink on different Petunia rootstocks, on rootstock quality parameters

| | | | | Sprout | Side-shoots | | Average |
|---|---|---|---|---|---|---|---|
| | Commercial | | Rooting | differentiation | from the | Average stem | elongation of |
| Var | name | model | potential(%) | from callus (%) | stem (%) | thickness (mm) | internodes (mm) |
| Petunia surfinia | Surfinia | White | 95 | 100 | 80 | 5 | 25 |
| Petunia surfinia | Surfinia | Burgundy | 95 | 80 | 80 | 8 | 10 |
| Petunia surfinia | Surfinia | Hot pink | 95 | 50 | 80 | 8 | 30 |
| Petunia surfinia | Surfinia | Purple | 95 | 10 | 80 | 7 | 10 |
| Petunia surfinia | Surfinia | Dark violet | 95 | 80 | 80 | 7 | 30 |
| Petunia surfinia | Surfinia | Yellow | 95 | 90 | 80 | 5 | 10 |
| Petunia surfinia | Surfinia | Blue spritz | 95 | 80 | 80 | 8 | 40 |
| Petunia surfinia | Surfinia | Pink spritz | 95 | 80 | 80 | 8 | 40 |
| Petunia sp. | Happy Giant | Hot pink | 95 | 50 | 80 | 10 | 50 |
| Petunia sp. | Bingo | White | 95 | 50 | 80 | 6 | 30 |
| Petunia sp. | Bingo | Blue | 95 | 60 | 80 | 8 | 30 |
| Petunia sp. | Bingo | Purple | 95 | 60 | 80 | 8 | 30 |
| Petunia sp. | Crazytunia | Mandeville | 95 | 30 | 80 | 7 | 40 |
| Petunia sp. | Crazytunia | Stone-wash | 95 | 30 | 80 | 7 | 30 |

2.1.3. Morphological identification of Labiatae—herb rootstocks produced from cuttings.

Reference is now made to Table 10, presenting rootstock quality parameters of grafted Ocimum, Origanum and Thymus. Different Ocimum scions were grafted on Ocimum kilimandscharicum×O. basilicum F1 ‘Magic Mountain’™ rootstock; Different Origanum or thymus scions were grafted on Origanum vulgare rootstock. All the tests were conducted twice, 5 replicates per rootstock. The desired tested qualities included maximal germination and rooting potential, minimal sprout differentiation from callus and/or side-shoots from the stem; maximal stem thickness and elongation of internodes.

TABLE 10
Rootstock quality parameters of grafted Ocimum, Origanum and Thymus

| | | | Sprout | Side-shoots | | Average |
|---|---|---|---|---|---|---|
| | Commercial | Rooting | differentiation | from the | Average stem | elongation of |
| Var | name | potential (%) | from callus (%) | stem (%) | thickness (mm) | internodes (mm) |
| Ocimum | Basil ‘Magic | 95 | 0 | 80 | 8 | 70 |
| kilimandscharicum × | Mountain’ ™ | | | | | |
| O. basilicum F1 | | | | | | |
| Origanum vulgare | Origanum | 95 | 20 | 70 | 3 | 20 |
| | vulgare | | | | | |
| Majorana syriaca | Za'atar | 95 | 20 | 70 | 3 | 30 |

3. Evaluation of Different Scion and Rootstock Combinations for Achieving Desirable High Stem Grafted Horticultural Plant.

Parameters and results are presented in Table 11.

3.1. Two stages have been tested for compatibility and grafting:
3.1.1. Proof of concept: grafting on short stem (4-6 cm) to evaluate compatibility between rootstock and scion and grafting potential (output). Different levels for compatibility were identified and their engrafted products were evaluated.
3.1.2. High stem feasibility: grafting on long stem (7-18 cm) to evaluate physical and physiological parameters.

3.2. Testing the life duration of different engrafting products—by preserving the engrafted plants and growing them for up to additional 12 months.

TABLE 11
Grafting different Solanaceae: vegetable scion varieties on different Solanaceae vegetable
rootstocks; evaluation of engrafted product and rootstock-scion reciprocal effect

| Rootstock | Tested Scion | Tested Scion models | Rootstock results | Scion results |
|---|---|---|---|---|
| Capsicum annum | Capsicum annum | Orange FTGG72; Red | Good rootstock | Normal physical |
| Maccabi | (Ornamental | FTGG73; Yellow | development (maximal | development, |
| | Pepper) Mambo ™ | FTGG74; Purple Red | thickness); few stem side- | similar to non- |
| | | FTGG75 | shoots | grafted control |
| Capsicum annum | Capsicum annum | Multicolor Orange | Good rootstock | Enhanced |
| Maccabi | (Ornamental | FTGG96; Multicolor | development (maximal | development - |
| | Pepper) Cubana ™ | Red FTGG97; Red | thickness); few stem side- | internode |
| | | FTGG92; Yellow | shoots | elongation, large |
| | | FTGG93 | | size crown, non- |
| | | | | regular (undesired) |
| Capsicum annum | Capsicum annum | Yellow; Red | Good rootstock | Unaffected by |
| Maccabi | (Ornamental | | development (maximal | rootstock; normal |
| | Pepper) Acapulco | | thickness); few stem side- | development similar |
| | | | shoots | to non-grafted |
| | | | | control |
| Capsicum annum | Capsicum annum | Red | Good rootstock | Unaffected by |
| Maccabi | F1 Ornamental | | development (maximal | rootstock; normal |
| | Pepper Treasures | | thickness); few stem side- | development similar |
| | Red | | shoots | to non-grafted |
| | | | | control |
| Capsicum annum | Capsicum annum | | Good rootstock | Unaffected by |
| Maccabi | Medusa | | development (maximal | rootstock; normal |
| | Ornamental | | thickness); few stem side- | development similar |
| | Pepper | | shoots | to non-grafted |
| | | | | control |
| Capsicum annum | Capsicum annum | Red E49.9524; Yellow | Good rootstock | Unaffected by |
| Maccabi | Sweet bite | E49.9526; | development (maximal | rootstock; normal |
| | | Orange E49.9531 | thickness); few stem side- | development similar |
| | | | shoots | to non-grafted |
| | | | | control |
| Solanum | Solanum | | stem does not get thicken, | Unaffected by |
| lycopersicum | lycopersicum | | poor sturdiness | rootstock; normal |
| Beaufort | Tomate Ponchi ™- | | | development similar |
| | Re F1 | | | to non-grafted |
| | | | | control |
| Solanum | Solanum | | stem does not get thicken, | Unaffected by |
| lycopersicum | lycopersicum | | poor sturdiness | rootstock; normal |
| Beaufort | Tomate Ponchi ™- | | | development similar |
| | Mi F1 | | | to non-grafted |
| | | | | control |
| Solanum | Solanum | | enhanced root system; | Enhanced |
| lycopersicum | lycopersicum | | stem get thicken, | development - |
| Beaufort | Dwarf tomato | | moderate sturdiness | internode |
| | TT33 | | | elongation, large |
| | | | | size crown, non- |
| | | | | regular (undesired) |
| Solanum | Solanum | | stem does not get | Unaffected by |
| lycopersicum | lycopersicum | | thicken, poor sturdiness | rootstock; normal |
| Arnold | Tomate Ponchi ™- | | | development similar |
| | Re F1 | | | to non-grafted |
| | | | | control |
| Solanum | Solanum | | stem does not get thicken, | Unaffected by |
| lycopersicum | lycopersicum | | poor sturdiness | rootstock; normal |
| Arnold | Tomate Ponchi ™- | | | development similar |
| | Mi F1 | | | to non-grafted |
| | | | | control |
| Solanum | Solanum | | enhanced root system; | Unaffected by |
| lycopersicum | lycopersicum | | stem does not get thicken, | rootstock; normal |
| Arnold | Ikram | | poor sturdiness | development similar |
| | | | | to non-grafted |
| | | | | control |
| Solanum | Solanum | | enhanced root system; | Enhanced |
| lycopersicum | lycopersicum | | stem get thicken, | development - |
| Arnold | Dwarf tomato | | moderate sturdiness | internode |
| | TT33 | | | elongation, large |
| | | | | size crown, non- |
| | | | | regular (undesired) |
| Solanum | Solanum | | stem does not get thicken, | Unaffected by |
| lycopersicum | lycopersicum | | poor sturdiness | rootstock; normal |
| Resistar F1 | Tomate Ponchi ™- | | | development similar |
| | Re F1 | | | to non-grafted |
| | | | | control |
| Solanum | Solanum | | stem does not get thicken, | Unaffected by |
| lycopersicum | lycopersicum | | poor sturdiness | rootstock; normal |
| Resistar F1 | Tomate Ponchi ™- | | | development similar |
| | Mi F1 | | | to non-grafted |
| | | | | control |
| Solanum | Solanum | | enhanced root system; | Enhanced |
| lycopersicum | lycopersicum | | stem get thicken, | development - |
| Resistar F1 | Dwarf tomato | | | internode |
| | TT33 | | moderate sturdiness | elongation, large |
| | | | | size crown, non- |
| | | | | regular (undesired) |
| Solanum | Solanum | | stem does not get thicken, | Unaffected by |
| lycopersicum | lycopersicum | | poor sturdiness | rootstock; normal |
| Submarine 001 | Tomate Ponchi ™- | | | development similar |
| | Re F1 | | | to non-grafted |
| | | | | control |
| Solanum | Solanum | | stem does not get thicken, | Unaffected by |
| lycopersicum | lycopersicum | | poor sturdiness | rootstock; normal |
| Submarine 001 | Tomate Ponchi ™- | | | development similar |
| | Mi F1 | | | to non-grafted |
| | | | | control |
| Solanum | Solanum | | enhanced root system; | Enhanced |
| lycopersicum | lycopersicum | | stem get thicken, | development - |
| Submarine 001 | TT33 Dwarf | | moderate sturdiness | internode |
| | tomato TT33 | | | elongation, large |
| | | | | size crown, non- |
| | | | | regular (undesired) |
| Solanum | Dwarf tomato | | stem does not get thicken, | Moderate effect by |
| melongena | TT33 | | good sturdiness | rootstock - less |
| Classic F1 | | | | vigor compared to |
| | | | | non-grafted control |

TABLE 12
Grafting different Solanaceae: Calibrachoa varieties on different Petunia rootstocks;
evaluation of engrafted product and rootstock-scion reciprocal effects

| Rootstock | Rootstock model | Tested Scion | Tested Scion models | Rootstock results | Scion results |
|---|---|---|---|---|---|
| Petunia surfinia | white | Calibrachoa sp. | Yellow banana; White | Undeveloped, thin, | Nutritional |
| | | Celebration ® | improved; Neon rose; | sprouts from callus; | deficiency |
| | | | Mandarin; Cherry; | Nutritional deficiency | (chlorosis); normal |
| | | | Violet | (chlorosis) | physical |
| | | | | | development, |
| | | | | | similar to non- |
| | | | | | grafted control |
| Petunia surfinia | Burgundy; hot | Calibrachoa sp. | Pink; Purple | Moderate rootstock | Unaffected by |
| | pink; purple; | Chameleon | | development (thickness) | rootstock; normal |
| | yellow; blue | | | sprouts from callus | development similar |
| | spritz; pink spritz | | | | to non-grafted |
| | | | | | control |
| | Dark violet | Calibrachoa sp. | Pink; Purple | Moderate rootstock | Unaffected by |
| | | Chameleon | | development (thickness) | rootstock; normal |
| | | | | No sprouts from callus | development similar |
| | | | | | to non-grafted |
| | | | | | control |
| Petunia sp. Happy | Hot pink | Calibrachoa sp. | Pink; Purple | Good rootstock | Unaffected by |
| Giant | | Chameleon | | development (maximal | rootstock; normal |
| | | | | thickness); moderate stem | development similar |
| | | | | side-shoots and sprouts | to non-grafted |
| | | | | from callus | control |
| Petunia sp. Happy | Hot pink | Calibrachoa sp. | mandarin; cherry | Good rootstock | Unaffected by |
| Giant | | Celebration ® | | development (maximal | rootstock; normal |
| | | | | thickness); moderate stem | development similar |
| | | | | side-shoots and sprouts | to non-grafted |
| | | | | from callus | control |
| Petunia sp. Bingo | White | Calibrachoa sp. | Pink; Purple | Undeveloped, thin, | Nutritional |
| | | Chameleon | | sprouts from callus; | deficiency |
| | | | | Nutritional deficiency | (chlorosis); normal |
| | | | | (chlorosis) | physical |
| | | | | | development, |
| | | | | | similar to non- |
| | | | | | grafted control |
| Petunia sp. Bingo | blue; Purple | Calibrachoa sp. | Pink; Purple | Good rootstock | Unaffected by |
| | | Chameleon | | development (well | rootstock; normal |
| | | | | thickness); stem side- | development similar |
| | | | | shoots and sprouts from | to non-grafted |
| | | | | callus | control |
| Petunia sp. | Mandeville | Calibrachoa sp. | Pink; Purple | undeveloped, thin, | Moderate |
| Crazytunia | | Chameleon | | moderate stem side-shoots | incompatibility 70% |
| | | | | and sprouts from callus | output |
| Petunia sp. | Stone-wash | Calibrachoa sp. | Pink; Purple | undeveloped, thin, | Moderate |
| Crazytunia | | Chameleon | | moderate stem side-shoots | incompatibility 70% |
| | | | | and sprouts from callus | output |

TABLE 13
Grafting different Labiatae: herb varieties on different rootstocks; evaluation
of engrafted product and rootstock-scion reciprocal effects

| Rootstock | Rootstock model | Tested Scion | Tested Scion models | Rootstock results | Scion results |
|---|---|---|---|---|---|
| Ocimum | Green-purple | Ocimum | green | Good rootstock | Unaffected by |
| kilimandscharicum × | | basilicum var. | | development (maximal | rootstock; normal |
| O. basilicum F1Basil | | minimum Basil ‘el | | thickness); moderate stem | development similar |
| ‘Magic Mountain’ ™ | | Greco’ | | side-shoots and sprouts | to non-grafted |
| | | | | from callus | control |
| Ocimum | Green-purple | Ocimum herbalea | Purple-green | Good rootstock | Unaffected by |
| kilimandscharicum × | | Basil ‘Wild | | development (maximal | rootstock; normal |
| O. basilicum F1Basil | | Magic’ | | thickness); moderate stem | development similar |
| ‘Magic Mountain’ ™ | | | | side-shoots and sprouts | to non-grafted |
| | | | | from callus | control |
| Ocimum | Green-purple | Ocimum herbalea | Purple-green | Good rootstock | Unaffected by |
| kilimandscharicum × | | Basil ‘Lahsa’ | | development (maximal | rootstock; normal |
| O. basilicum F1Basil | | | | thickness); moderate stem | development similar |
| ‘Magic Mountain’ ™ | | | | side-shoots and sprouts | to non-grafted |
| | | | | from callus | control |
| Ocimum | Green-purple | Ocimum herbalea | Dark purple | Good rootstock | Unaffected by |
| kilimandscharicum × | | Basil ‘Dark Lady’ | | development (maximal | rootstock; normal |
| O. basilicum F1 Basil | | | | thickness); moderate stem | development similar |
| ‘Magic Mountain’ ™ | | | | side-shoots and sprouts | to non-grafted |
| | | | | from callus | control |
| Origanum vulgare | Green | Origanum vulgare | Green | stem does not get thicken, | Unaffected by |
| | | | | good sturdiness | rootstock; normal |
| | | | | | development similar |
| | | | | | to non-grafted |
| | | | | | control |
| Majorana syriaca | Green | Majorana syriaca | Green | stem does not get thicken, | Unaffected by |
| Za'atar | | Za'atar | | good sturdiness | rootstock; normal |
| | | | | | development similar |
| | | | | | to non-grafted |
| | | | | | control |
| Majorana syriaca | Green | Origanum | Green-gold | stem does not get thicken, | Unaffected by |
| Za'atar | | ‘Aureum Gold’ | | good sturdiness | rootstock; normal |
| | | | | | development similar |
| | | | | | to non-grafted |
| | | | | | control |
| Majorana syriaca | Green | Origanum | Green-white | stem does not get thicken, | Unaffected by |
| Za'atar | | ‘Aureum | | good sturdiness | rootstock; normal |
| | | Variegata’ | | | development similar |
| | | | | | to non-grafted |
| | | | | | control |
| Majorana syriaca | Green | Origanum | Green | stem does not get thicken, | Unaffected by |
| Za'atar | | ‘Compactum’ | | good sturdiness | rootstock; normal |
| | | | | | development similar |
| | | | | | to non-grafted |
| | | | | | control |
| Origanum vulgare | Green | Origanum | Green-gold | stem does not get thicken, | Unaffected by |
| | | ‘Aureum Gold’ | | good sturdiness | rootstock; normal |
| | | | | | development similar |
| | | | | | to non-grafted |
| | | | | | control |
| Origanum vulgare | Green | Origanum | Green-white | stem does not get thicken, | Unaffected by |
| | | ‘Aureum | | good sturdiness | rootstock; normal |
| | | Variegata’ | | | development similar |
| | | | | | to non-grafted |
| | | | | | control |
| Origanum vulgare | Green | Origanum | Green | stem does not get thicken, | Unaffected by |
| | | ‘Compactum’ | | good sturdiness | rootstock; normal |
| | | | | | development similar |
| | | | | | to non-grafted |
| | | | | | control |
| Origanum vulgare | Green | Thymus ‘Tabor’ | Green | stem does not get thicken, | Moderate |
| | | | | good sturdiness | incompatibility 50% |
| | | | | | output |

3.3. Process for selection of grafting products:
3.3.1. Four high-stem grafting product lines have been selected. These products comprise high-stem grafted varieties with commercial added value, which distinguishes them from the source scion varieties in esthetic and horticultural traits and utilization. Different rootstocks and scions combinations have been identified and selected suitable for commercial protocol usage. In one aspect, rootstock-scion combinations which enhance stem thickness and sturdiness have been screened for and identified.

Reference is Now Made to High Stem Pepper Grafting Products.

The Capsicum annum ‘Maccabi’ has been found to be suitable as a rootstock. Its advantageous traits include: producing straight trunk, woodiness and having only few nodes (1-2). This variety was tested for engrafting with 6 selected Capsicum annum scions (15 different models), yielding 3 different grafting products:
3.3.1.1. Grafting with ornamental pepper Mambo™, or Medusa. It was demonstrated to develop desirable rootstock to scion proportion (i.e. 1:2:1, pot height:trunk height:crown height with high uniformity, respectively, as observed in 95% of the grown plants), continuous flowering, i.e. for at least 6 months and decorative fruit yield and long shelf life (about 1 year).

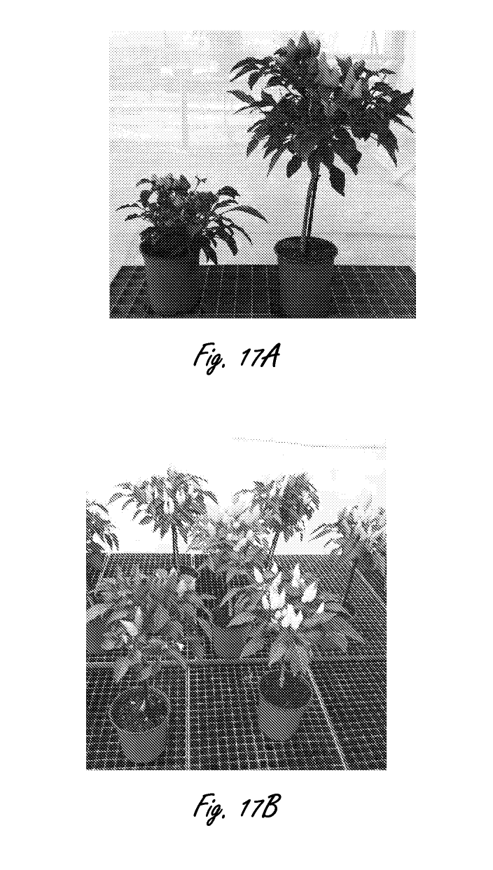

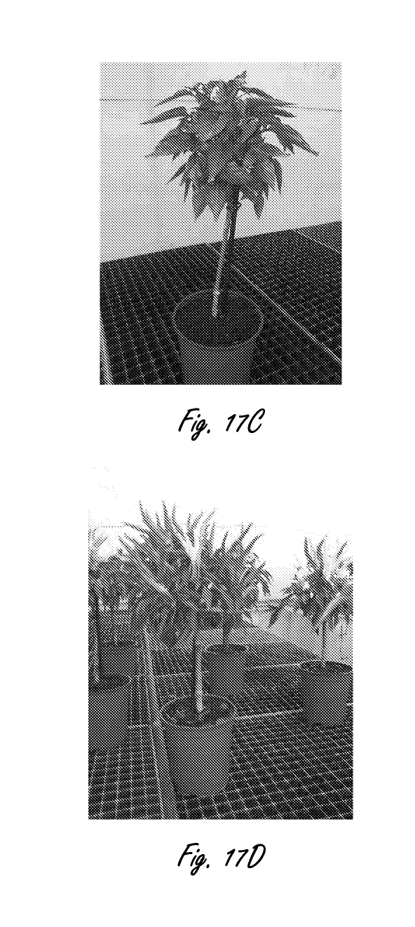

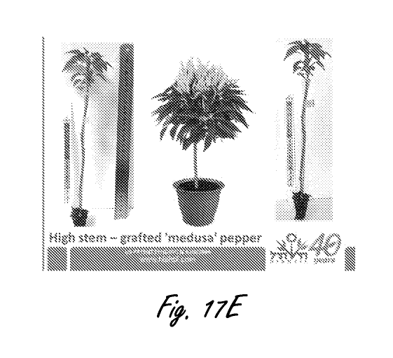

Reference is now made to FIG. 17 photographically illustrating some embodiments of the high stem grafted pepper products according to the present invention. FIG. 17A shows on the left side—non-grafted Capsicum ornamental ‘Treasurs’, and on the right side—high stem grafted Capsicum ornamental ‘Mambo™’ on Capsicum ‘Maccabi’ rootstock; FIG. 17B shows different models of grafted Capsicum ornamental Mambo™ on Capsicum ‘Maccabi’ rootstock; FIG. 17C shows Capsicum ornamental ‘Mambo™’ grafted on Capsicum ‘Maccabi’ rootstock; FIG. 17D shows Capsicum ornamental ‘Medusa’ grafted on Capsicum ‘Maccabi’ rootstock; FIG. 17E shows seedling specifications (left and right sides of the figure) of grafted Capsicum ornamental ‘Medusa’ on Capsicum ‘Maccabi’ rootstock. A mature high stem grafted pepper plant comprising Capsicum ornamental ‘Medusa’ grafted on Capsicum ‘Maccabi’ rootstock is presented in the middle of the figure. It can be seen that the grafting point of the scion on the rootstock is about 16 cm and more from the ground.

Reference is now made to FIG. 17F presenting a production protocol and product description for high stem grafted capsicum annum plant, as an embodiment of the present invention:

Product Specification:

Grafted Capsicum, the rootstock is Capsicum annum (var. High stem); the scion is Capsicum annum (var. ‘Medusa’ ornamental pepper/conic);
Plant height: 20-30 cm above the pot rim;
Crown diameter: 10-15 cm;
Trunk height: 17-20 cm;
Trunk diameter: 0.5-0.8 mm;
Dozens of flowers set fruits all year. The colors and taste (sweet or hot) of the fruits depend on the scion variety; the edibleness of the fruits depends on the growing protocol.
The finished high stem grafted plant product is designed for planting into a 1 liter container or pot, but can be also grown in various pot sizes, especially from 1 to 3 liters;
Crop development time from planting to colored fruits: 2-3 months subjected to growing conditions;
Growth season: perennial
Growth temperature: 15° C. at night, 22° C. by day, generally between 13° C. and 40° C.;
Radiation: full sun to half shade at summer; full sun at winter;
Ventilation: preferably, increased pollination and reduced moisture at crown zone;
Fertilization: increased fertilization is essential in the winter, with fertilizer optionally be applied on sunny days. In further aspects, moderate fertilization is applied in the summer time.

Agro-Techniques:
Suitable for organic management (minimal registered PGR's, pesticides and chemicals);
Heavy growth media (weight to volume), or heavy pot (i.e. pot made from heavy material such as clay, iron, steel, wood, or thick plastic) is recommended for stabilization of the mature or finished high stem grafted plant or product;
Support with stakes and rings may be required for about two months or until the trunk thickens sufficiently to support the crown weight;
Pruning is not necessary; however it may be useful for thickening the trunk and promote overall lignification;
Removing the first developed fruits to increase crown volume, although it may delay the development of mature fruits;
The trunk may lengthen or stretched by cutting off the lower branches;
Harsh trimming is possible provided that a minimum of about 25% of the foliage is kept to allow fast recovery;
Rootstock side shoots are removed (may be performed in the first weeks of growth);
Overhead watering and wet crown should be avoided;

Plant Protection:

No exposure to any commercial insecticide permitted for use on vegetables.
3.3.1.2. Grafting with ornamental pepper Cubana™, Treasures, or Acapulco. Resulted in large crown development, which needed additional support (such as stick), and fitted 1-5 liter pots. It developed a tree-shape with trunk that got thicker following trimmings.
3.3.1.3. Grafting with ‘Sweet bite’ pepper. The grafted plant developed a 50 cm height pepper tree which is suitable for 3-5 liter pots and yielding consumable fruits.

Reference is Now Made to High Stem Tomato Grafting Products.

The ‘Resistar’ rootstock was found to have advantageous traits such as uniformity and generation of long internodes which enable commercial high stem grafting. It has been found that the combination of rootstock and scion affect rootstock thickening in the high-stem tomato. Out of the tested varieties, only the dwarf tomato TT33 has been found to induce rootstock thickening.

It has been demonstrated that the combination of TT33 with the Resistar rootstock is uniform and enable well-development and yielding crown formation on a thicken stem.

The combination of the ‘Resistar’ rootstock with the scion Ponchi™-Re F1 or Ponchi™-Mi F1 fit to 1 liter pot, have a good proportion (i.e. about 1:2:0.7 pot height:trunk height:crown height, respectively), compact crown, yielding flowers and fruits, although requiring physical support (stick) since the stem thickening and sturdiness is limited.

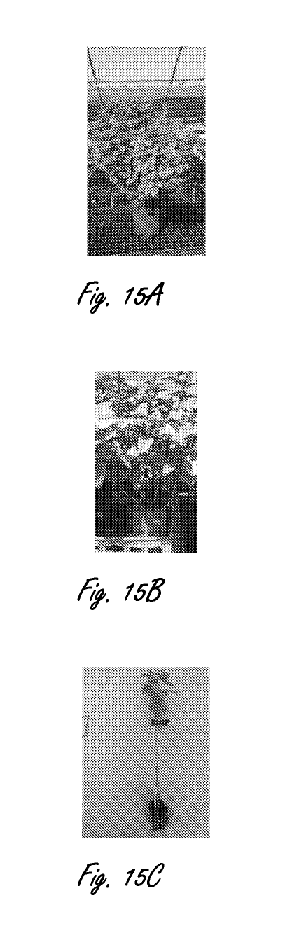

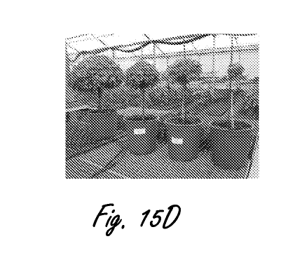

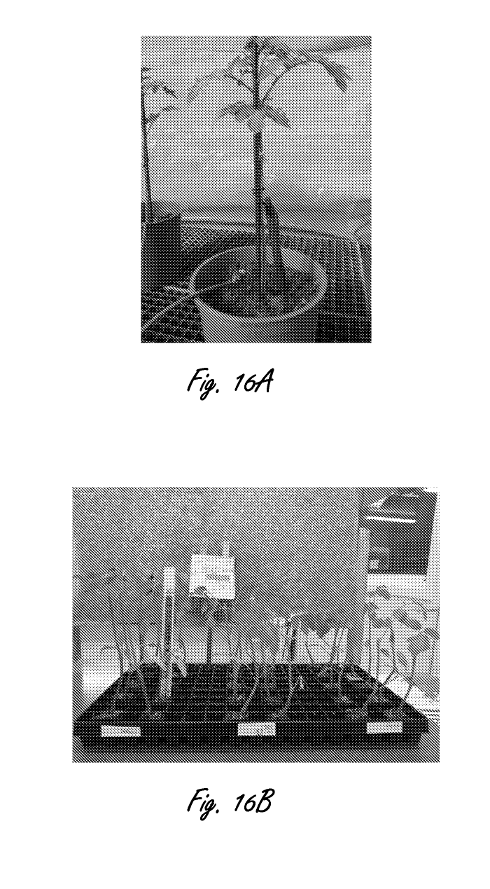

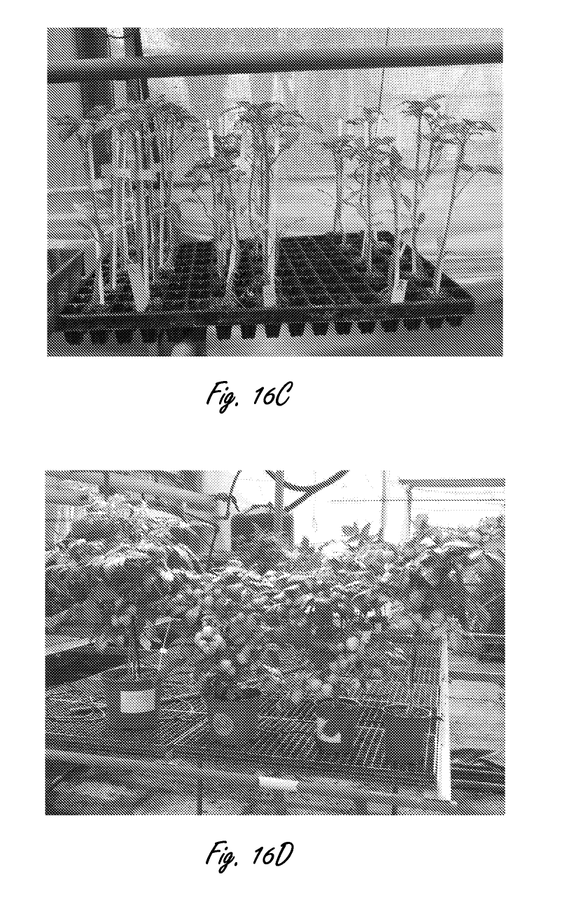

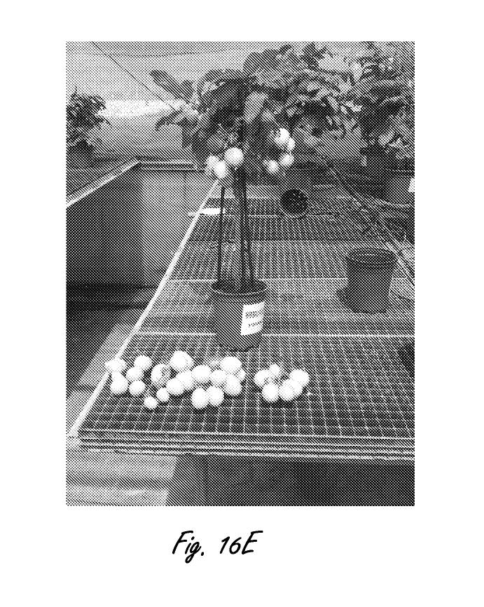

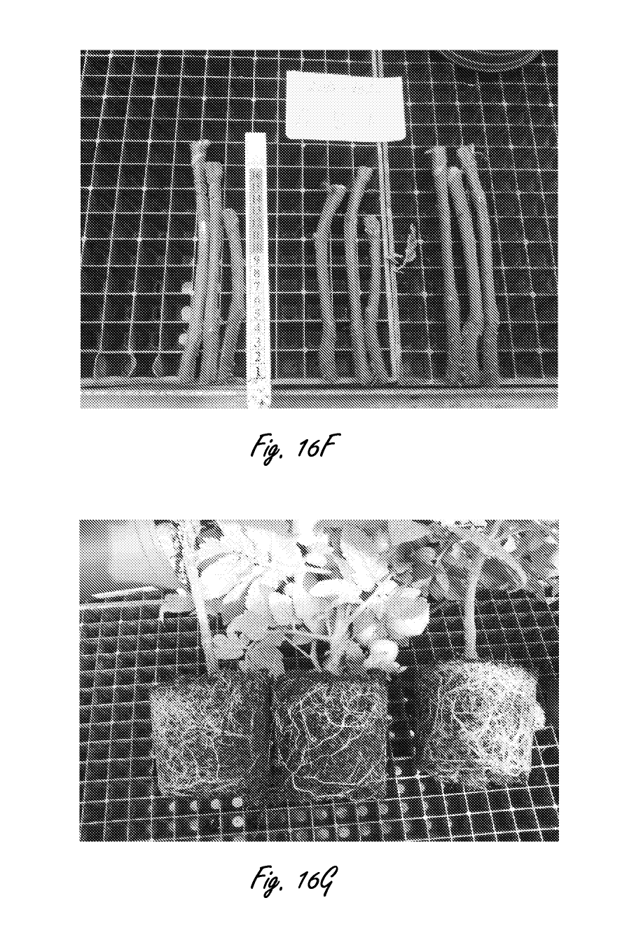

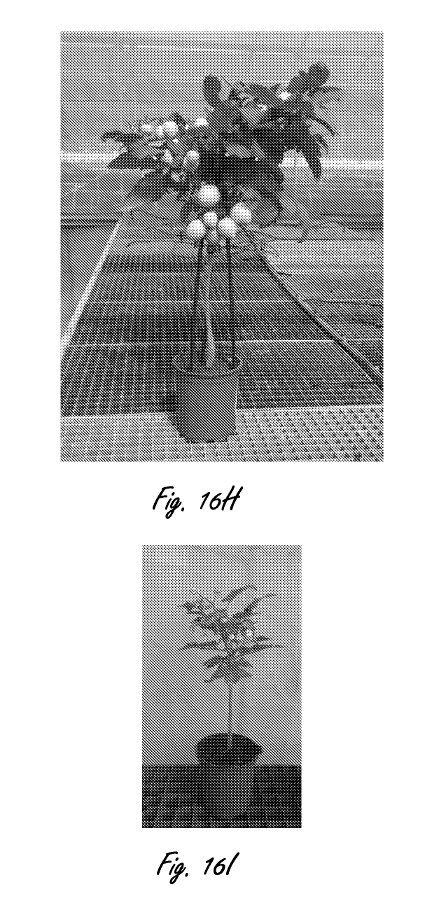

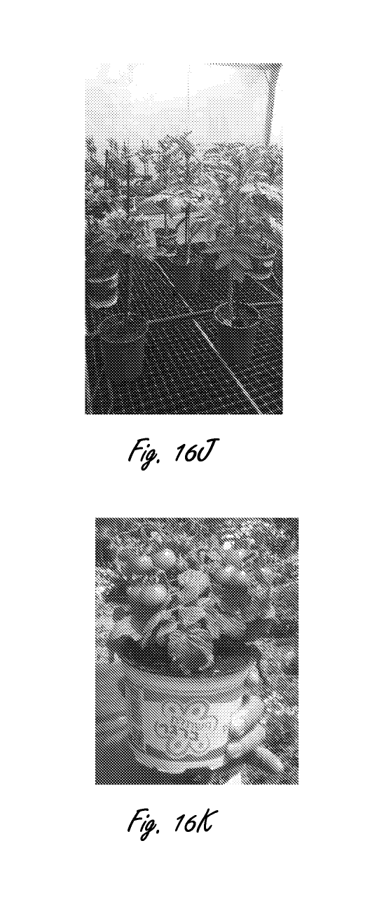

Reference is now made to FIG. 16, photographically illustrating high stem tomato products. FIG. 16A presents high stem grafted tomato plant comprising Ikam scion grafted on Arnold rootstock. FIG. 16B presents illustration of rootstock preparation for grafting at first leaf height. Varieties ‘Resistar’, ‘Bufor’ and ‘Arnold’ are shown from left to right, respectively. It can be seen that ‘Resistar’ has the most uniform, high and thick growth characteristics. It also develops quicker relative to the other tested rootstock varieties.

Reference is now made to FIG. 16C, photographically presenting grafting of TT33 scion on different rootstocks (left to right) ‘Resistar’; ‘Bufor’ and ‘Arnold’, respectively. In each pair of seedlings left was grafted at first leaf height; right was grafted at second leaf height.

Reference is now made to FIG. 16D, photographically presenting high stem grafted tomato comprising TT33 scion grafted on different rootstocks, compared to non-grafted TT33 tomato. From left to right: grafted on ‘Arnold’ rootstock and planted within 17 cm pot; non-grafted TT33 control planted in 17 cm pot; non-grafted TT33 control planted within 1 Liter pot; grafted on ‘Resistar’ rootstock and planted in 1 Liter pot. It can be seen that the grafted plants comprising both rootstock varieties demonstrated enhanced scion vegetative growth (including internodes, leaf size) relative to the non-grafted control plants.

Reference is now made to FIG. 16E, photographically presenting TT33 scion grafted on ‘Resistar’ rootstock. The fruits of the grafted plant achieved coloration 60 days after planting.

Reference is now made to FIG. 16F photographically presenting TT33 scion grafted on different rootstocks, from left to right, ‘Arnold’, ‘Bufor’ and ‘Resistar’, respectively. This figure demonstrates the effect of the rootstock on stem development. It can be seen that ‘Resistar’ is the most uniform and high rootstock. It is further seen that the thickness is similar at this stage between the different rootstocks.

Reference is now made to FIG. 16G photographically presenting the effect on root system development, of grafting TT33 scion on different rootstocks; from left to right, TT33 scion grafted on ‘Arnold’ rootstock, non-grafted TT33 plant; TT33 scion grafted on ‘Resistar’ rootstock. It can be seen that the grafted TT33 scion plants (with both rootstocks) demonstrated a significantly enhanced developed root system relative to the non-grafted TT33 plant. The ‘Resistar’ rootstock grafted plant presented the most developed root system.

Reference is now made to FIG. 16H photographically presenting a high stem grafted tomato plant according to an embodiment of the present invention. It can be seen that the combination of dwarf TT33 tomato as a scion with the Resistar rootstock results in a plant comprising a uniform and well-developed yielding crown, on a thicken stem.

Reference is now made to FIG. 16I photographically presenting a high stem grafted tomato plant comprising Tomate Ponchi™-Re F1 as a scion, grafted on ‘Resistar’ rootstock, as an alternative embodiment of the present invention.

Reference is now made to FIG. 16J photographically presenting a high stem grafted tomato plant, according to some embodiments of the present invention. Right: Tomate Ponchi™-Re F1 grafted on submarine 001 rootstock; Left Dwarf tomato TT33 grafted on Resistar rootstock.

Reference is now made to FIG. 16K photographically presenting a non-grafted dwarf tomato commercial product in a pot, as a comparison to the grafted high stem dwarf tomato plant of the present invention.

Reference is Now Made to High Stem Calibrachoa Grafting Products.

Two rootstocks and four scions have been identified and selected as suitable for commercial protocol usage.

The Petunia sp. ‘Happy giant’ model ‘Hot pink’ has been found to be suitable for usage as a rootstock. Its advantageous traits include: production of straight trunk, woody, less nodes, secondary shoot growth from the callus bridge. This variety was tested for engrafting with 4 selected Calibrachoa sp. scions, i.e. ‘Chameleon’ model Pink and Purple and Celebration® model mandarin and cherry.

An additional rootstock, Petunia surfinia model ‘Dark violet’ is a further example of a rootstock which can be grown by the protocol of the present invention to be well suited for high stem grafting according to embodiments of the present invention. This rootstock has been grafted with the two tested scions, Calibrachoa sp. ‘Chameleon’ model Pink or Purple. It developed straight and woody trunk without any sprouts from the callus. The scions have been developed well, with green color and dense flowering.

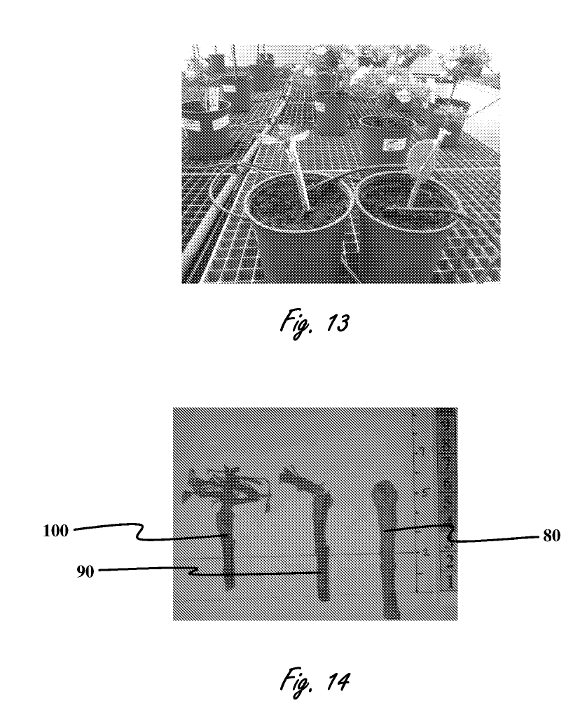

Incompatibility was recorded between the rootstocks Petunia sp. ‘Crazytunia’ models Mandeville and Stone-was, and the scions Calibrachoa sp. ‘Chameleon’ models Pink and Purple. These grafted plants did not develop (see FIG. 13) and 30% of them wilted.

Reference is Now Made to High Stem Basil Grafting Products.

The Ocimum kilimandscharicum×O. basilicum F1 ‘Magic Mountain’™ has been found to be suitable as a rootstock. Its advantageous traits included: tolerance to cold and biotic stress, production of straight trunk, woody, with few nodes (1-2). This variety was tested for engrafting with 4 selected basil scions. Grafting with Ocimum basilicum var. minimum ‘el Greco’ resulted in production of a unique ball-shaped crown with desired leaf-size, and aroma. The trunk continued to get thicken following trimmings. The grafted plant is tolerant to stress (drought, cold) compared with the non-grafted scion.

Reference is now made to FIG. 15 photographically illustrating Basil grafting products. FIG. 15A presents Ocimum basilicum var. minimum ‘el Greco’ plant, used as a scion, FIG. 15B presents Ocimum kilimandscharicum×O. basilicum F1 ‘Magic Mountain’™ plant, used as a rootstock, FIG. 15C presents high stem grafted basil seedling and FIG. 15D presents high stem grafted basil in different growth stages of 1, 4, 14 and 40 weeks old, from right to left, respectively.

Further high-stem grafted herbs product lines included grafted Origanum vulgare and Majorana syriaca rootstocks.

High stem origanum: A compatibility with different origanum varieties was recorded.

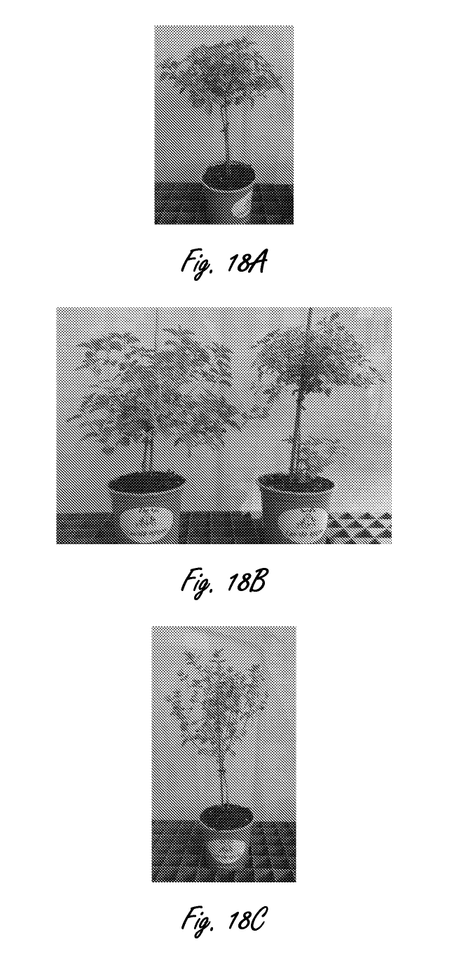

Reference is now made to FIG. 18, photographically illustrating high stem grafted Origanum products. FIG. 18A presents high stem grafted Origanum vulgare. FIG. 18B presents some embodiments of the high stem grafted Origanum of the present invention: Left—grafted rooted Origanum vulgare (short stem). Right—High stem grafted Origanum ‘Aureum Variegata’ on Majorana syriaca Za'atar rootstock. At the bottom of the pot—shoots from the rootstock. FIG. 18C presents high stem rootstock test of Majorana syriaca Za'atar, grafted on itself.

High stem thymus: grafting success of 80% and moderate incompatibility was recorded.

Reference is now made to high stem grafted basil tree description and growth protocol, as examples of embodiments of the present invention.

In some aspects, the finished grafted plant is suitable for planting in a 3-liter container, but can be grown in various pot sizes from 1 to 10 liters.

Product Specification:

Reference is now made to some parameters of a mature grafted basil tree in a 3 liter pot:

Height: about 35-38 cm high above the pot rim

Crown diameter: about 25 cm

Trunk height: about 18-22 cm

Trunk diameter: about 7-8 mm

Reference is now made to some parameters of a mature grafted basil tree in a 1 liter pot:

Height: about 30-35 cm high above the pot rim

Crown diameter: about 14-20 cm

Trunk height: about 17-20 cm

Trunk diameter: about 5-8 mm

Crop time: about 6-24 weeks subjected to growing conditions and desired end-product.

Agro-Techniques:

According to one embodiment, support with stakes and rings may be required for about 2 months or until the trunk sufficiently thickened to support the crown weight.

According to another embodiment, trimming is recommended once a week during the first month of growth. Thereafter, trimming is used for crown shaping and flowering prevention, subjected to the rate of growth. The average frequency may be every second week in the summer and once a month in the winter. Usage of trimming is adapted to give the crown a spherical shape; to thicken the trunk and to promote overall lignification and woodification. The trunk can be lengthened by cutting off the lower branches.

According to a further embodiment, harsh trimming is possible provided that a minimum of 25% of the foliage is kept on to allow fast recovery.

According to a further embodiment, rootstock side shoots should be removed (may occur in the first weeks of growth).

According to a further embodiment, abscission of leaves may occur, but can be reduced by frequent trimming and by avoiding over-watering.

According to a further embodiment, overhead watering and wet crown should be avoided.

Growth temperatures: between about 10° C. and about 40° C., more particularly, about 16° C. at night, about 24° C. by day.

According to a further embodiment, full sun exposure may result in enhancement of production of compact and healthy plants.

Growth seasons of the grafted plants: perennial. Flowering prevention by clipping off buds is recommended, yet not necessary.

Fertilization: increased fertilization is essential in the winter, with fertilizer to be applied on sunny days. In the summer time, usage of low level of fertilizers or avoidance of fertilizers is recommended.

Plant Protection:

Susceptible to Botrytis blight. Infection can be prevented by heating and by using good ventilation cycle for humidity reduction. Prophylactic application of fungicides is recommended.

Infections of Peronospora sp. may be treated with Ridomil (Metalaxyl-M).

Susceptibility to aphids may be observed in the summer. No exposure to any commercial insecticide permitted for use on herbs.

Grafted Basil tree has tolerance to temporary drought stress and tolerance to short-term cold stress; if splinting is performed quickly, easy recovery from diseases and pest infestations, as well as from breakage may be achieved.

4. Commercial Evaluation:

This stage included developing prototypes adapted for potential clients comprising selected varieties and performing adaptations to the market demands, for example, desired scions, new scions, height of final grafted plant or product, adaptations of rootstock height and grafted head diameter to fit desired pot proportions.
4.1. High stem pepper: Based on the Capsicum annum Maccabi rootstock, 3 scion series were further tested and developed for growth protocols and marketing:
   4.1.1. The Mambo™ series comprises the conic-fruit type, decorative and can be consumed as hot pepper.
   4.1.2. The ‘Medusa’ type is multi-color and has sweet fruits.
   4.1.3. The sweet bite series was designed according to costumer demand for 40-60 cm high-stem which can be integrated with other edible plants at the same growth-container.
4.2. High stem Basil: this product was the first to be rapidly produced (6 weeks to finished pot) and in large scale production. It provides a novel basil tree. The combination of tolerant rootstock which is thickened possibly like a small tree trunk during growth at the consumer site, with a scion having decorative and desired aroma qualities, make this high stem grafted product a tree-like, single high stem, product enduring for years.
4.3. High stem Calibrachoa: Based on the new Calibrachoa sp. ‘chameleon’ series as scions, 5 engrafted products were developed for commercial scale usage: The Petunia sp. ‘Happy giant’ model ‘Hot pink’ was grafted with Calibrachoa sp. scions: ‘Chameleon’ model Pink and Purple and Celebration® model mandarin and cherry; Petunia surfinia model ‘Dark violet’ was grafted with Calibrachoa sp. ‘Chameleon’ model Purple.
   4.3.1. Reference is now made to FIG. 14 presenting a photographic illustration of grafting point breakdown of Calibrachoa sp. Chameleon pink grafted upon Petunia surfinia pink. It is shown in replicates 80, 90 and 100 that a weak adhesion and different rootstock and scion development lead to unequal diameter and physical sensitivity between the rootstock and scion.
   4.3.2. Thus the grafting protocols and products of the present invention are designed to achieve the following desirable grafting horticultural parameters:
      4.3.2.1. Improved compatibility between the rootstock and the scion
      4.3.2.2. Uniform adhesion point: similar shoot diameters between rootstock and scion; without noticeable callus.
      4.3.2.3. Fast adhesion (5-10 days from grafting to adhesion).
      4.3.2.4. Suppression of continuous formation of side-shoots from the stem or sprouts from the callus.
      4.3.2.5. Rootstock-scion combinations which enhance stem thickness and sturdiness.
      4.3.2.6. Usage and development of trailing and stabilizing means for supporting and shaping the grown rootstock or scion.

1. A high stem grafted herbaceous plant, wherein said grafted plant comprises herbaceous scion engrafted upon a rootstock of up to 10 mm diameter, at a predetermined height of at least 10 cm.

2. The high stem grafted plant according to claim 1, wherein said scion is engrafted upon said rootstock at a predetermined height of between about 10 cm and about 50 cm.

3. The high stem grafted plant according to claim 1, wherein said scion is engrafted upon said rootstock at a predetermined height of between about 16 cm and about 20 cm.

4. The high stem grafted plant according to claim 1, wherein said scion is of length of between about 10 cm and about 30 cm.

5. The high stem grafted plant according to claim 1, wherein at least one of the following holds true:
a. said rootstock is herbaceous plant;
b. said scion and/or said rootstock is derived from a hybrid plant;
c. said scion and said rootstock belong to a family selected from the group consisting of: Solanaceae, Lamiaceae (or Labiatae), Lobeliaceae, Asteraceae, Scrophulariaceae, Caryophyllaceae and Cucurbitaceae;
d. said scion is a Calibrachoa genus and said rootstock is a Petunia genus or wherein the genus of said rootstock and said scion is selected from the group consisting of Physalis, Ocimum, Solanum and Capsicum; and
e. said rootstock is Solanum melongena and said scion is a species selected from the group consisting of: Solanum melongena, S. betaceum (Tamarillo) and Physalis philadelphica (Tomatillo).

6.-10. (canceled)

11. The high stem grafted plant according to claim 1, wherein said scion is at least one of the following:
a. selected from the group consisting of: ‘Lobelia’, ‘Lobelia erinus’, Gerbera, Gazania, Bidens, Bidens ferulifolia, Bacopa, Bacopa monnieri, Dianthus, Dianthus chinensis, Angelonia, Lycopersicon lycopersicum, Lycopersicon lycopersicum cherry tomatoes, Thymus, Lavandula, Origanum, Salvia, Artemisia, Artemisia abrotanum and Majorana syriaca zaatar;
b. selected from the group of Capsicum species consisting of: C. annuum, C. baccatuum, C. chinense, C. frutescents and C. pubescen and any combination thereof;
c. an ornamental pepper variety or cultivar;
d. selected from the group of Ocimum species, cultivars or varieties consisting of: Ocimum×africanum, Ocimum americanum, Ocimum amicorum, Ocimum angustifolium, Ocimum basilicum, Ocimum burchellianum, Ocimum campechianum, Ocimum canescens, Ocimum carnosum, Ocimum centraliafricanum, Ocimum circinatum, Ocimum coddii, Ocimum cufodontii, Ocimum dambicola, Ocimum decumbens, Ocimum dhofarense, Ocimum dolomiticola, Ocimum ellenbeckii, Ocimum empetroides, Ocimum ericoides, Ocimum filamentosum, Ocimum fimbriatum, Ocimum fischeri, Ocimum formosum, Ocimum forskoelei, Ocimum fruticosum, Ocimum grandiflorum, Ocimum gratissimum, Ocimum hirsutissimum, Ocimum irvinei, Ocimum jamesii, Ocimum kenyense, Ocimum kilimandscharicum, Ocimum labiatum, Ocimum lamiifolium, Ocimum masaiense, Ocimum mearnsii, Ocimum metallorum, Ocimum minimum, Ocimum minutiflorum, Ocimum mitwabense, Ocimum monocotyloides, Ocimum motjaneanum, Ocimum natalense, Ocimum nudicaule, Ocimum nummularia, Ocimum obovatum, Ocimum ovatum, Ocimum pseudoserratum, Ocimum pyramidatum, Ocimum reclinatum, Ocimum serpyllifolium, Ocimum serratum, Ocimum somaliense, Ocimum spectabile, Ocimum spicatum, Ocimum tenuiflorum, Ocimum transamazonicum, Ocimum tubiforme, Ocimum urundense, Ocimum vandenbrandei, Ocimum vanderystii, Ocimum viphyense, Ocimum waterbergense, Ocimum×citriodorum (O. americanum×O. basilicum), Lemon basil, Ocimum kilimandscharicum basilicum ‘Dark Opal’, African blue basil, basilicum, kilimandscharicum, minimum, herbalea, ‘Globe’ basil, ‘dwarf’ basil, ‘French’ basil, Ocimum basilicum var. minimum ‘Greek’ Basil, entries of Ocimum accessions described in Table 1 of Yariv Ben Naim et al (2015) Resistance Against Basil Downy Mildew in Ocimum Species, Genetics and Resistance Vol. 105 and any combination thereof; and
e. selected from the group of Calibrachoa species consisting of: Calibrachoa caesia, Calibrachoa calycina, Calibrachoa dusenii, Calibrachoa eglandulata, Calibrachoa elegans, Calibrachoa ericaefolia, Calibrachoa excellens, Calibrachoa hassleriana, Calibrachoa heterophylla, Calibrachoa humilis, Calibrachoa linearis, Calibrachoa parviflora, Calibrachoa pygmaea, Calibrachoa rupestris, Calibrachoa sellowiana, Calibrachoa spathulata and Calibrachoa thymifolia.

12.-17. (canceled)

18. The high stem grafted plant according to claim 1, wherein said rootstock is at least one of the following:
a. belongs to a family selected from the group consisting of Solanaceae and Lamiaceae or Labiatae;
b. selected from the group consisting of Cestroideae, Goetzeoideae, Nicotianoideae, Petunioideae, Schizanthoideae, Schwenckioideae and Solanoideae subfamily;
c. selected from the group of Petunia species consisting of: P. alpicola, P. altiplana, P. axillaris, P. bajeensis, P. bonjardinensis, P. exserta, P. guarapuavensis, P. helianthemoides, P. humifusa, P. inflate, P. integrifolia, P. interior, P. ledifolia, P. littoralis, P. mantiqueirensis, P. occidentalis, P. parviflora, P. patagonica, P. pubescens, P. reitzii, P. riograndensis, P. saxicola, P. scheideana, P. variabilis, P. villadiana, P.×atkinsiana and P. hybrida; and
d. selected from the group of species consisting of: Capsicum annuum, Ocimum basilicum, Solanum lycopersicum L., S. tuberosum and S. melongena.

19.-22. (canceled)

23. The high stem grafted plant according to claim 1, wherein said grafted plant comprises engrafted pairs of compatible rootstock and scion selected from the group consisting of a rootstock of the Petunia genus engrafted with a scion of the Calibrachoa genus, a rootstock of the Capsicum annuum species engrafted with a scion of the Ornamental pepper Capsicum annuum species, a rootstock of the Ocimum species engrafted with a scion of the Ocimum species, a rootstock of the solanum lycopersicum species engrafted with a scion of the S. lycopersicum species, a rootstock of the solanum melongena species engrafted with a scion of the S. lycopersicum species, a rootstock of the solanum melongena species engrafted with a scion of the S. melongena species, and a rootstock of the Origanum vulgare species engrafted with a scion of the O. vulgare species.

24. The high stem grafted plant according to claim 1, wherein said grafted plant is derived from grafted high stem propagation material selected from the group consisting of grafted high stem young plants and grafted high stem unrooted raw material.

25. The high stem grafted plant according to claim 24, wherein at least one of the following holds true:
a. said young plants are selected from the group consisting of rooted cuttings, seedlings, grafted high stem rooted cuttings and grafted high stem seedlings;
b. said unrooted raw material is selected from the group consisting of unrooted cuttings and grafted high stem unrooted cuttings;
c. said unrooted raw material is adapted for insertion and growth in plug trays; and
d. said grafted high stem unrooted raw material is adapted for perpendicular stability and/or sturdiness when planted in a plug tray.

26.-28. (canceled)

29. A high stem grafted finished plant derived from the propagation material of claim 24.

30. The high stem grafted finished plant according to claim 29, wherein said plant is adapted for perpendicular stability and/or sturdiness when planted in a pot or planting container, or wherein said plant is adapted for planting as bedding plants.

31.-32. (canceled)

33. The high stem grafted plant according to claim 32, wherein at least one of the following holds true:
a. said at least one compatible characteristic is selected from the group consisting of: stem diameter, growth pattern, taxonomical similarity, genetic similarity, anatomical similarity, growth rate, enhanced or reduced flowering, enhanced or reduced fruit size, enhanced or reduced fruit yield, internode number, internode diameter, internode and/or stem color, stem habit, root stock and/or scion woodification, and any combination thereof; and
b. the compatibility between said rootstock and said scion is caused by a characteristic selected from the group consisting of metabolic, developmental, anatomical and any combination thereof.

34.-35. (canceled)

36. The high stem grafted plant according to claim 35, wherein said rootstock and/or said scion has said at least one desirable agronomical, horticultural and/or ornamental characteristic of said rootstock is selected from the group consisting of strong root system, enhanced stem height or high stem, plant vigor, vigorous growth, sturdiness, stress tolerance, resistance or tolerance to biotic stress, resistance or tolerance to disease agents such as viruses, bacteria, fungi, resistance or tolerance to pests and weeds, disease resistance or tolerance, pest resistance or tolerance, resistance to pathogens, resistance to insect infestation, prevention of contaminants penetration to the scion, resistance to abiotic stress, resistance to nutrient deficiencies, improved seed yield, improved growth rate, desirable interaction between said rootstock and said scion, induced dwarfism, induced scion-crown density, enhanced vigor, induced sturdiness and/or thickness of said rootstock, enhanced germination, enhanced rooting potential, minimal sprout differentiation from callus, minimal side-shoots from the rootstock stem, enhanced rootstock stem thickness, maximal elongation of internodes, robustness, straight stem, thickness, color and any combination thereof.

37. The high stem grafted plant of claim 36, wherein at least one of the following holds true:
a. the stress tolerance characteristic comprises an abiotic stress tolerance characteristic selected from the group consisting of cold tolerance, high temperature tolerance, drought tolerance, flood tolerance, salt tolerance, ionic phytotoxicity tolerance, pH tolerance and any combination thereof;
b. the stress tolerance characteristic comprises a biotic stress tolerance characteristic selected from the group consisting of a disease resistance, an insect resistance, tolerance to parasitic weeds, a nematode resistance, improved resistance to soil borne pests and any combination thereof; and,
c. said desirable agronomical and/or horticultural characteristic is selected from the group consisting of a rooting potential of at least 80%, sprout differentiation from callus lower than 80%, side shoots from the stem lower than 90%, average stem thickness of at least 5 mm, average internode length of at least 10 mm and any combination thereof.

38.-39. (canceled)

40. The high stem grafted plant according to claim 1, wherein at least one of the following holds true:
a. said rootstock is engrafted with at least two different scions said scions belong to different varieties and are compatible with said rootstock;
b. said scion is characterized by at least one characteristic selected from the group consisting of dense flowering, unique flower color, low to moderate incompatibility with the rootstock, at least 50% output of developed plants, desirable aroma, enhanced fruit yield, dense foliage, upright fruits, small conic fruits, many fruits in cluster, different colors, short nodes, compact crown, many branches, unripe fruits, large fruits, un-clustered fruits, short to medium internodes, vigorousness, large and tall crown, compactness, branched, colourful fruits, sweet taste, non-pungent fruits, non-toxic, long internodes, high yield, multiple taste, multiple flower colors, dwarf and compact, tolerance to root and foliage diseases, crown shape, standard commercial yield, stress tolerance, dense flowering, unique colors, natural ball-shaped crown, creeping stems, and any combination thereof;
c. said high stem grafted plant has at least one desirable ornamental, horticultural and/or agronomical characteristic relative to a corresponding non-grafted scion plant, said at least one characteristic is selected from the group consisting of: desirable ornamental or esthetic design, enhanced height or high stem plant, avoidance of new root development or secondary root development from the upper parts of the plant, limitation of pruning wounds, sturdiness, strong root system, tolerance to biotic stress, tolerance to abiotic stress, tolerance to soil borne pests and diseases, tolerance to parasitic weeds, prevention of contaminants penetration to the scion, uniformity, reduced leaf yellowing, robust growth, plant vigor, vigorous growth, desirable aroma, color, enhanced inflorescence yield, enhanced fruit yield, enhanced fruit size, enhanced fruit number, enhanced yield of plant propagation material such as cuttings, enhanced aerial yield, combination of more than one species or variety on one plant, normal development similar to a corresponding non-grafted control plant, and any combination thereof; and
d. said high stem rootstock is compatible with grafting machines or other automatic and/or mechanic agro techniques.

41.-49. (canceled)

50. Any plant part, cuttings or unrooted cuttings, grafted cuttings, or grafted unrooted cuttings of the high stem grafted herbaceous plant according to claim 1.

51. (canceled)

52. High stem grafted propagation material, wherein said high grafted stem propagation material comprises a scion engrafted upon a rootstock of up to 10 mm diameter, at a predetermined height of at least 10 cm, further wherein said high stem propagation material is selected from the group consisting of grafted high stem young plants, grafted high stem rooted cuttings, grafted high stem unrooted cuttings and grafted high stem seedlings.

53. A method for producing a high stem grafted herbaceous plant comprising steps of:
a. providing a herbaceous scion plant;
b. selecting rootstock plants which are compatible with said scion plant;
c. rooting said rootstock plants and selecting rootstock with a rooting potential of at least 80%;
d. growing said rootstock plant under predetermined agrotechnical conditions so as to produce a rootstock of up to 10 mm diameter with a predetermined stem height of at least 10 cm and growth characteristics suitable for grafting with said scion;
e. growing said herbaceous scion plant under agrotechnical conditions, so as to provide a scion with growth characteristics suitable for grafting with said rootstock; and
f. grafting said scion onto said rootstock at said predetermined stem height of at least 10 cm, thereby producing a high stem grafted herbaceous plant.

54.-87. (canceled)

88. The method according to claim 20, wherein said method is useful for producing a herbaceous high stem grafted plant comprising a scion tolerant to or free of soil borne pests.
